(19) United States
(12) Patent Application Publication
(10) Pub. No.: US 2011/0055066 A1
(43) Pub. Date: Mar. 3, 2011

(54) System and Method for Enabling Financial Planning

(75) Inventors: Joel Craig THEMMEN, Carlsbad, CA (US); Paul Jacob THIESSEN, Winnipeg (CA); Dilip Arun OGALE, Winnipeg (CA); Christopher Daniel ROSNEY, Winnipeg (CA); Wesley PETROWSKI, Winnipeg (CA); Robert Frank URBONAS, Winnipeg (CA)

(73) Assignee: EMERGING INFORMATION SYSTEMS INC., Winnipeg (CA)

(21) Appl. No.: 12/869,439

(22) Filed: Aug. 26, 2010

Related U.S. Application Data
(60) Provisional application No. 61/237,847, filed on Aug. 28, 2009.

(51) Int. Cl. G06Q 40/00

(52) U.S. Cl. 705/35

(57) ABSTRACT

A system and method for financial planning are provided. The system includes a financial planning engine, storage, a client database, and a set of pre-defined components. The financial planning engine generates financial plans. The client database is maintained in the storage and stores client data. The client data includes personal data and client parameters. The set of pre-defined components is stored in the storage. The components include a set of controls for communicating data with the client database, and for presenting outputs from the financial planning engine. The pre-defined components are designed to be included in a financial planning interface. The financial planning engine has a set of pre-defined function objects. Each of the function objects corresponds to one of the components and is used by the financial planning engine for handling communication with the one component.

This application claims priority from U.S. Provisional Patent Application Ser. No. 61/237,847 filed on Aug. 28, 2009, the contents of which are incorporated herein by reference.

### FIELD OF THE INVENTION

The present invention relates generally to financial services. More specifically, the present invention relates to a method and system for enabling financial planning

### BACKGROUND OF THE INVENTION

Financial planning interfaces are known. Examples include financial planning Web sites that are available to the public, and financial advisor interfaces that allow a financial advisor to prepare a detailed financial plan for a client. Typically, these interfaces are Web-based, due to the portability of the platform. Financial planning interfaces are generally operated by financial services firms and provide tools of varying complexity for performing financial planning after inputting some data, such as age and annual salary, and parameters, such as, for example, desired retirement age and desired retirement income. The term “financial plan”, as used herein, means the analysis and/or projection of one or more aspects of a client's finances. Further, the term “client”, as used herein, includes both potential and existing clients of a financial services firm.

These financial planning interfaces are custom-built each time, whether they are client- or financial advisor-facing. If the target market for the financial planning interface is the public, a small, core set of calculators are integrated with the financial planning interface to provide certain functionality. The interface is custom-built for the purpose of collecting the small amount of input data required to perform the simple calculations. Thus, the interface contains few data entry boxes, options and other controls. The controls are tied to the calculation logic and the output area or screen is designed for the particular outputs of the simple calculators. The development and testing of such controls and output can be onerous and is prone to errors.

Financial advisor interfaces are much more complex, as they generally control all of the various details and options for preparing a complete financial plan via a full-featured financial planning engine. They are highly-tested, as their results are relied upon by clients for long-term financial planning.

Client-facing interfaces, such as financial planning Web sites, generally use a different financial planning engine than that used by financial advisor interfaces. As a result, discrepancies can arise as a result of the potentially-different logic used to generate the calculated results. Further, other discrepancies can occur due to the use of error-checking logic that differs from that employed in the financial advisor interface and/or financial planning engine to which it is tied. The consequence is that the results calculated by the client-facing interfaces often differ from those calculated by the financial planning engine via the financial advisor interface.

It is an object of the invention to provide a novel system and method for enabling financial planning

### SUMMARY OF THE INVENTION

According to an aspect of the invention, there is provided a method for financial planning, comprising:

a financial planning engine for generating financial plans;

storage;

a client database maintained in said storage for storing client data, said client data including personal data and client parameters; and

a set of pre-defined components stored in said storage, said components comprising a set of controls for communicating data with said client database, and for presenting outputs from said financial planning engine, said pre-defined components being designed to be included in a financial planning interface,

said financial planning engine having a set of pre-defined function objects, each of said function objects corresponding to one of said components and being used by said financial planning engine for handling communication with said one component.

The system can include a set of pre-defined slide layouts stored in the storage, the slide layouts having areas for receiving the components to generate the financial planning interface. The system can also include slide definitions stored in the storage, the slide definitions defining the assembly of the slide layouts and the components into slides. The system can further include presentation definitions stored in the storage, the presentation definitions identifying a plurality of the slide definitions representing the slides to be assembled into a presentation. The system can also include a presentation editor for generating the slide definitions and the presentation definitions.

The system can further include a presentation player for providing access to the financial planning interface, the presentation player assembling the slide layouts and the components in the storage according to the slide definitions to generate the slides of the financial planning interface. The presentation player can be accessible via a Web interface.

At least two of the presentation definitions can identify a common one of the slide definitions.

The presentations can be linked to a launch page available through the presentation player. The launch page can permit selection of a client whose client data is used for the presentations.

The presentation player can insert navigation controls in the slides.

The presentation editor can provide a graphical user interface for creating the slides and the presentations.

The set of controls can enable the generation of a financial plan via the financial planning engine for a selected client. The components can enable the display of the financial plan generated by the financial planning engine.

The components can perform validity checks on data inputted via the controls.

The function objects can perform validity checks on data received from the components.

According to another aspect of the invention, there is provided a method for enabling financial planning, comprising:

providing a set of pre-defined components, said components comprising a set of controls for communicating data with a client database that includes personal data and client parameters, and for presenting outputs from a financial planning engine for generating financial plans, said pre-defined components being designed to be included in a financial planning interface; and

providing said financial planning engine having a set of pre-defined function objects, each of said function objects corresponding to one of said components, said function objects being used by said financial planning engine for handling communication with said components.

The method can include providing a set of pre-defined slide layouts having areas for receiving the components to generate the financial planning interface. The method can further include assembling the slide layouts and the components to generate the financial planning interface.

The method can include generating slide definitions defining the assembly of the slide layouts and the components into slides.

The method can include assembling the slide layouts and the components according to slide definitions.

The method can include assembling a presentation according to a presentation definition identifying a plurality of the slide definitions representing slides.

The method can include generating a presentation definition identifying a plurality of the slide definitions representing the slides to be assembled into a presentation.

The method can include receiving input data via one of the components in the slides, and storing the input data in the client database.

The method can include:

receiving a request for a calculation from said financial planning engine via one of said components in said slides;

performing said calculation using said input data; and

sending said calculation from said financial plan to said one component.

According to a further aspect of the invention, there is provided a system for enabling financial planning, comprising:

a set of slides, said slides being assembled from slide layouts and pre-defined components, said components comprising a set of controls for communicating data with a client database that includes personal data and client parameters, and for presenting outputs from a financial planning engine for generating financial plans; and

a financial planning engine having a set of pre-defined function objects, each of said function objects corresponding to one of said components, said function objects being used by said financial planning engine for handling communication with said components.

According to yet another aspect of the invention, there is provided a method for enabling financial planning, comprising:

providing a set of pre-defined components, said components comprising a set of controls for communicating data with a client database that includes personal data and client parameters, and for presenting outputs from a financial planning engine for generating financial plans, said financial planning engine having a pre-defined set of function objects, each of said controls corresponding to one of said set of pre-defined function objects and generating events handled by said one function object; and

assembling said components into slides for presentation to a user.

### BRIEF DESCRIPTION OF THE DRAWINGS

An embodiment will now be described, by way of example only, with reference to the attached Figures, wherein:

FIG. 1 shows a schematic representation of a financial planning system in accordance with an embodiment of the invention and its working environment;

FIG. 2 shows a schematic diagram of the some of the components of the financial planning system of FIG. 1;

FIG. 3 shows a number of software and data elements of the financial planning system of FIG. 1;

FIG. 4 illustrates an exemplary screen of a financial advisor interface of FIG. 3;

FIG. 5 shows an extensible hypertext markup language (“XHTML”) page of the financial advisor interface of FIG. 3;

FIG. 6 illustrates the population of the XHTML page of FIG. 5 with components;

FIG. 7 shows the population of the components in the XHTML page of FIG. 6 with client data;

FIG. 8 illustrates the actual assembly of various graphical user interface (“GUI”) elements of a screen of the financial advisor interface;

FIG. 9 shows the screen of the financial advisor interface after construction as shown in FIG. 8;

FIG. 10 shows an exemplary landing page displayed via the presentation player of FIG. 3;

FIG. 11 shows a typical slide of a presentation as rendered via the presentation player of FIG. 3;

FIG. 12 shows a table of the various navigation button functions of the slide of FIG. 3;

FIG. 13 illustrates the construction of a slide of a presentation using the presentation editor of FIG. 3;

FIG. 14 shows the injection of a component into a slide layout in accordance with a slide definition;

FIG. 15 shows the merging of client data with the component in the slide shown in FIG. 14;

FIG. 16 shows the injection of controls into the slide of FIG. 15;

FIG. 17 illustrates the slide of FIG. 16 after injection of the controls;

FIG. 18 shows a slide containing multiple components;

FIGS. 19 and 20 illustrate the field-naming convention employed by the presentation module of FIG. 3;

FIG. 21 illustrates a slide containing an output component as rendered via the presentation player of FIG. 3;

FIG. 22 shows a slide after insertion of client data into a text component of the slide as rendered via the presentation player of FIG. 3;

FIG. 23 shows various presentations and their slides defined using the presentation editor of FIG. 3, and various resources that are employed in generating those slides/presentations;

FIG. 24 shows the XML for a presentation definition created by the presentation editor of FIG. 3;

FIG. 25 shows the XML for a slide definition created by the presentation editor of FIG. 3;

FIG. 26 shows the XML for a slide layout generated by the presentation editor of FIG. 3;

FIGS. 27A and 27B show the XHTML for a component referenced by the slide definition of FIG. 25;

FIG. 28 shows a landing page rendered via the presentation player of FIG. 3;

FIG. 29 shows a presentation management screen presented by the presentation editor after activating the “Open Editor” button of the landing page of FIG. 28;

FIG. 30 shows a table of the functions of the presentation management buttons shown on the presentation management screen of FIG. 29;

FIG. 31 shows a pop-up window displayed by the presentation editor when a new presentation is generated via the presentation management buttons shown in FIG. 29;

FIG. 32 shows a table of the presentation types that can be selected for a new presentation via the pop-up window of FIG. 31;

FIG. 33 shows a presentation editor screen generated by the presentation editor of FIG. 3;

FIG. 34 shows a table of the functions of the presentation editing buttons shown on the presentation editor screen of FIG. 33;

FIG. 35 shows a blank slide having two text areas generated by activating the “Add a New Slide” button on the presentation editor screen of FIG. 33;

FIG. 36 shows a blank slide similar to that shown in FIG. 35 having text and component areas;

FIG. 37 shows the editing of a text area of the slide of FIG. 36;

FIG. 38 shows a pop-up list enabling selection of a component for injection in a component area of the slide of FIG. 36;

FIG. 39 shows the slide of FIG. 36 after insertion of the component in the component area and text in two text areas;

FIG. 40 shows a table of various HTML editor controls of the presentation editor of FIG. 3 that are available for adding links to a text region of a slide;

FIG. 41 shows a pop-up window displayed by the presentation editor when inserting a link to an external Web page via the “Insert/Edit Link” button of FIG. 40;

FIG. 42 shows a menu displayed by the presentation editor that enables selection of a slide to link to when the “Link to Slide” button of FIG. 40 is activated;

FIG. 43 shows a menu displayed by the presentation editor that enables selection of a calculator to link to when the “Link to Calculator” button of FIG. 40 is activated;

FIG. 44 shows the addition of images to text areas of a slide via the presentation editor of FIG. 3;

FIG. 45 shows a list of shared slides presented by the presentation editor when the “Add a Shared Slide” button of the presentation editor screen of FIG. 33 is activated;

FIG. 46 shows the addition of a shared slide of a presentation to the slide library using the presentation editor of FIG. 3;

FIG. 47 shows a slide management screen generated by the presentation editor of FIG. 3;

FIG. 48 shows a table of the slide management buttons of the slide management screen of FIG. 47 and their functions;

FIG. 49 shows a resource management screen generated by the presentation editor of FIG. 3; and

FIG. 50 shows a table of resource management buttons of the resource management screen of FIG. 49 and their functions.

### DETAILED DESCRIPTION OF THE EMBODIMENTS

The invention enables a highly-customizable user interface, hereinafter referred to as a presentation, for interacting with a financial planning engine. A presentation is an “alternative” user interface that enables interaction with the financial planning engine on a financial planning system in a highly-customizable manner. The presentation consists of one or more slides. The slides are constructed via slide definitions that reference slide layouts that describe the number of elements on a slide and how they are positioned. The slide definitions also reference the particular elements used to populate various areas of the slide layouts. The elements can include components, images, text, video, etc. A presentation editor is a graphical user interface application that enables users to create slides to collect data input for a financial plan, store the data collected, perform calculations for the financial plan using the financial planning engine, display the financial plan in the presentation, and generate reports and graphs.

The components that enable the presentations to accept input data and display output are defined groups of controls (such as input boxes, drop-down lists, radio buttons, etc.). Each component generally includes related controls that are bundled together for ease of selection and relevance. The components have some logic to perform preliminary validation of inputs, where required. A function object on the financial planning system associated with the component handles inputs and outputs from and to each component. The function objects are used by the financial planning engine to send and receive data from the components and typically include more comprehensive validation functionality than is available via the component. In this manner, presentations serve as live ties to the financial planning engine.

The invention can be used to rapidly and safely generate and deploy presentations that are customized for a particular purpose (such as a sales opportunity). These customized presentations can collect the appropriate amount of data required for generating a financial plan for the particular purpose and provide specific output related to such purpose (such as to help lead a client to a specific buying decision). By bundling the controls into pre-defined components, fast data entry screens that provide a targeted approach to addressing a specific topic (e.g., 3 or 4 screens to collect the essential inputs needed to perform, for example, a retirement analysis) can be created. Controls that expose other data that may be unrelated to the goal of the presentation can be omitted, thereby keeping the presentation focused. Data collected and analysis performed using a presentation may also be retained and built on for subsequent targeted sales presentations.

As presentation slides can incorporate the same input components used in the financial advisor interface and augment them with explanatory slides, presentations can be created that walk a user through the data entry and analysis process to help train users on how to use various features of a financial advisor interface that is generally used to access the financial planning engine.

Further, as the components are tested prior to use within a presentation, presentations can be deployed out into a production environment quickly without further validation. Thus, users can use and create presentations on a variety of topics for a variety of purposes over time and make those presentations available to their work force, without the need to develop and test new code.

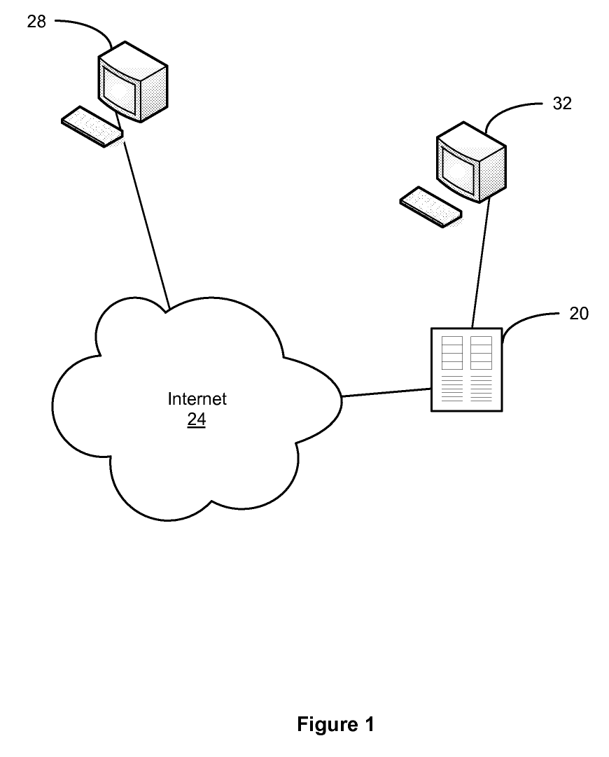

FIG. 1 is a high-level schematic diagram of a financial planning system 20 operated by a financial services firm and its working environment, in accordance with an embodiment of the invention. The financial planning system 20 manages the financial planning and advice delivery process for the financial services firm. The financial planning system 20 is coupled to a network such as the Internet 24. The financial planning system 20 enables interaction with the financial planning functionality via a traditional financial advisor interface that is Web-based and thus accessed via a Web browser.

A financial advisor's personal computer (“PC”) 28 is used to access a traditional financial advisor interface for accessing functionality and data available on the financial planning system 20.

A presentation editor uses another PC 32 to create and edit presentations and slides that are stored by the financial planning system 20.

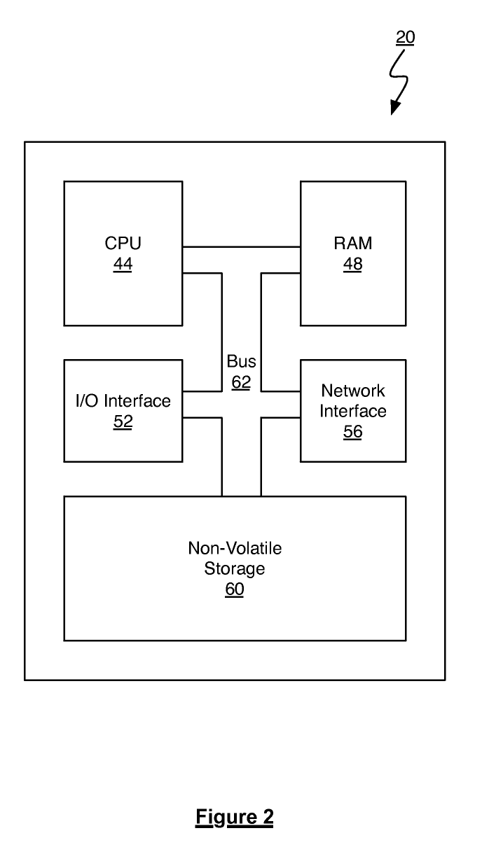

FIG. 2 shows various physical components of the financial planning system 20. The financial planning system 20 illustrated is one or more computers that cooperatively provide the functionality required. Where there is more than one computer, the computers can be in communication with one another over a local area network, or can be distributed remotely and in communication with each other via one or more communication networks, including, for example, the Internet 24. In the embodiment described herein, the financial planning system 20 consists of a single computer.

As shown, the financial planning system 20 has a number of components, including a central processing unit (“CPU”) 44, random access memory (“RAM”) 48, an input/output (“I/O”) interface 52, a network interface 56, non-volatile storage 60, and a local bus 62 enabling the CPU 44 to communicate with the other components. The CPU 44 executes computer-executable instructions for implementing an operating system and programs that provide the desired functionality. RAM 48 provides relatively responsive volatile storage to the CPU 44. The I/O interface 52 allows for input to be received from one or more devices, such as a keyboard, a mouse, etc., and outputs information such as to a display and/or speakers. The network interface 56 permits communication with other systems for sending and receiving presentations and parts thereof, client data, obtaining demand or productivity data, communicating results, etc. Non-volatile storage 60 stores the computer-executable instructions for implementing the operating system and programs, as well as various data resources.

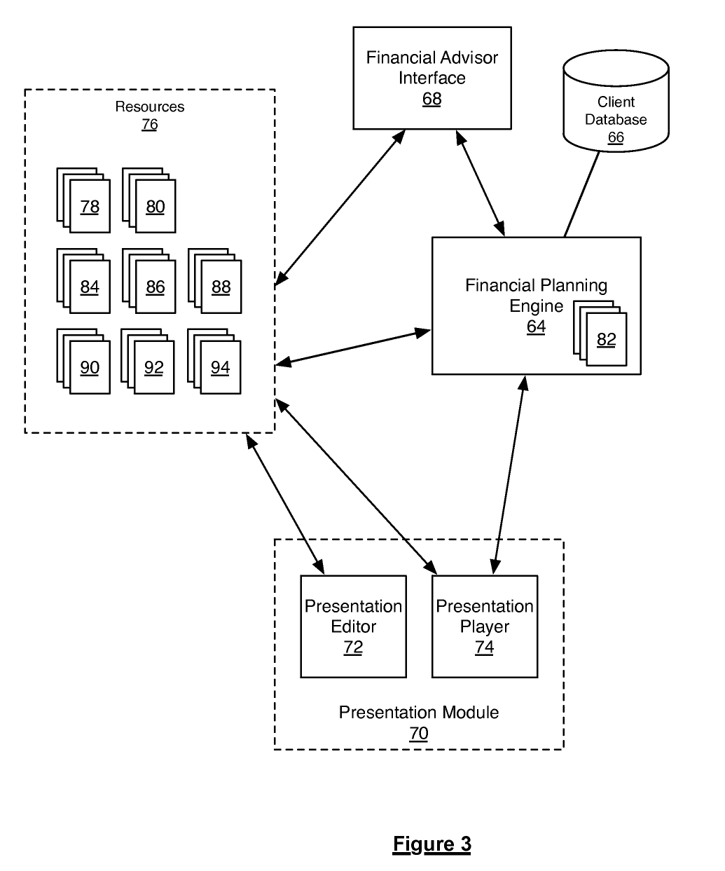

FIG. 3 shows a number of software and data elements of the financial planning system 20 stored in the non-volatile storage 60 thereof. A financial planning engine 64 is an application that receives input data for clients, and then generates financial plans, reports and graphs for them. The financial planning engine 64 stores client data in and retrieves client data from a client database 66 that stores personal data, client parameters, and assumptions. Personal data includes items such as name, address, age, salary, etc. Client parameters are used to prepare the financial plans and can include the client's target retirement age, what level of risk he is comfortable with in his financial portfolio, etc. Assumptions include the rate of return on his investments, the rate at which his salary is expected to grow, etc.

The financial planning engine 64 generates financial plans on behalf of various user interfaces. The user interfaces can be configured to provide base data, parameters and assumptions where not provided by the user. The financial planning engine 64 is designed to use the data, parameters and assumptions provided by the interface and use default parameters and assumptions where the interface does not provide the same. While varying levels of accessibility are available through the various interfaces, the financial planning engine 64 leverages a single calculation and report engine to generate calculated results and financial plans.

A financial advisor interface 68 is in communication with the financial planning engine 64 and provides financial advisors with a tool for preparing financial plan calculations for its clients. The financial advisor interface 68 is the traditional mode for accessing the financial planning engine 64 and is a comprehensive Web interface that exposes all of the detailed client data, assumptions and parameters for all the different scenarios that the financial planning engine 64 handles. As it is designed to provide access to all of the functionality of the financial planning engine 64 to a financial advisor who is assumed to be experienced with the financial advisor interface 68, it can be challenging to navigate through for a newer financial advisor, and it can generally be unsuitable for the majority of people, including clients, who have little or no training in its use.

A presentation module 70 also interfaces with the financial planning engine 64. The presentation module 70 includes a presentation editor 72 and a presentation player 74. The presentation editor 72 enables users to create and edit presentations. The presentation player 74 enables users to “play” presentations made with the presentation editor 72 for interacting with the financial planning engine 64.

The presentation module 70 is similar to the financial advisor interface 68, in that it provides a Web interface for presentations. The presentation module 70 is in communication with the financial planning engine 64 for accessing the client data stored in the client database 66 and performing financial planning The presentation module 70 provides a layer of abstraction between users and the financial planning engine 64 so that presentations can leverage the power of the financial planning engine 64, workflow functions and data stored within the client database 66 in a consolidated manner without having a deep knowledge of its inner workings or data format, as may be required to a degree with the financial advisor interface 68.

A set of resources 76 are also stored in non-volatile storage 60 of the financial planning system 20. The resources 76 include report and graph templates 78 that are employed by the financial planning engine 64 to generate reports and graphs used in presenting information via the financial advisor interface 68 or via presentations rendered by the presentation player 74.

Additionally, the resources 76 include components 80. The components 80 are defined in XHTML and represent sets of one or more interrelated controls that are used by the financial advisor interface 68 and the presentation module 70 for data input or exposing data previously stored in the client database 66 and for outputting calculations generated by the financial planning engine 64. Examples of such controls include input boxes, drop-down lists, check boxes, sliders, graphs and reports. The controls bundled together in a component 80 may be, for example, input boxes for various monthly expenses, graphs that display relation information, etc.

Each component 80 is associated with a separate one of a set of function objects 82 that is integrated in the financial planning engine 64. Each function object 82 includes handler code for each of the events generated by the corresponding component 80. Interaction with a control in a component 80 can cause the component 80 to generate an event and to communicate the event to the financial planning engine 64 for handling by the corresponding function object 82.

The resources 76 include XHTML pages 84 and navigation elements 86 that are used by the financial advisor interface 68. The pages 84 and navigation elements 86 assume to provide a financial advisor application and are relatively-static, in that their content, excluding the dynamic content from the client database 66 and the financial planning engine 64, and links generally do not change. The pages 84 encapsulate various components 80 for exposing the functionality of the financial planning engine 64 and the client data stored in the client database 66. The navigation elements 86 are provided to enable navigation between the various pages 84.

Other resources 76 that are employed solely by the presentation module 70 include slide layouts 88, images 90, slide definitions 92 and presentation definitions 94. Slide layouts 88 are pre-defined and pre-tested, like the components 80, so that they can be used in presentations without significant testing.

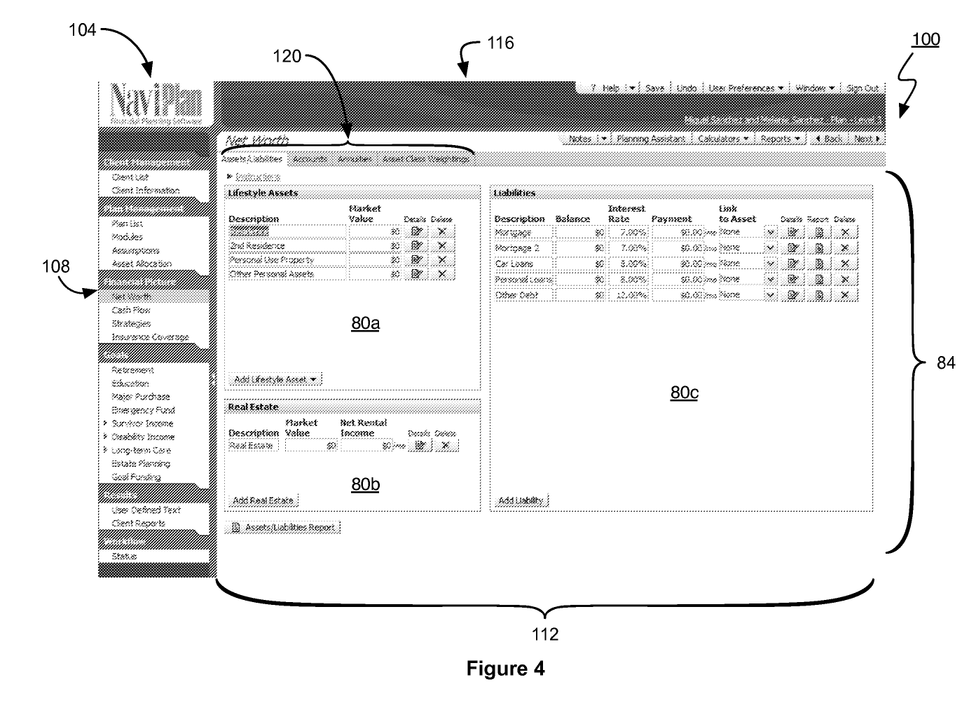

FIG. 4 illustrates an exemplary screen of the financial advisor interface 68 at 100. The screen 100 is divided into several areas as shown. A logo area 104 enables a financial institution to brand the financial advisor interface 68 as desired. A navigation menu 108 is common to almost all screens available through the financial advisor interface 68 and enables quick navigation to other pages 84. A content area 112 includes generally-dynamic content, including a banner 116, a set of tabs 120 and a page 84. The banner 116 contains both relative and absolute navigation buttons on the right side. Each of the tabs 120 is associated with a different page 84. The navigation menu 108, the banner 116 and the tabs 120 are all navigation elements 86.

Users navigate through the financial advisor application provided by the financial advisor interface 68 by clicking the Back and Next buttons in the banner 116, by selecting a page from the navigation menu 108 or by selecting one of the tabs 120. What pages 84 are visible and the order of the pages 84 is defined in a configuration file that essentially maps pages 84 into a navigational hierarchy. The navigation menu 108 provides a visual representation of that hierarchy of pages 84.

Each page 84, in turn, can contain a set of components 80 and/or text areas. The exemplary page 84 shown contains three components 80, 80a, 80b and 80c. Each component 80 can contain multiple related input fields and controls.

Components 80 are groupings of user input controls (or fields). Component 80a, labeled “Lifestyle Assets”, contains a table of values and a button to add more rows to the table. Component 80b, labeled “Real Estate”, is also a table. Component 80c, labeled “Liabilities”, is also a table with a button to add more rows. The rows of each table consist of input fields and buttons. These fields act together and are used by the browser to collect user input and post it to the financial planning system 20. The “Add” buttons in these components 80 are not part of the tables but are built into the components 80 themselves and act on the table contained within the component 80.

Each field in a component 80 has JavaScript associated that performs client-side (i.e. within the browser) validation of the input text to ensure that it conforms to the appropriate data type associated with the input field (e.g., the text represents a valid date for date fields, the text represents a valid number for numeric fields and so on). Simple range checking can also be performed by JavaScript code at the browser (e.g., that a value is within a minimum and maximum range of values). Before a page 84 is posted to the application the input fields are validated by the JavaScript code and if validation fails the user is prompted to fix the field(s) that are not valid.

Referring again to FIG. 3, all of the fields for a given component 80 are also associated with a server-side function object 82, which is the code responsible for processing events from those fields or processing the input text when those fields are posted to the presentation. Thus, each component 80 has a corresponding function object 82. In turn, each function object 82 manages the behavior of that specific component 80, its input fields and other controls (e.g., buttons), regardless of what page 84 contains that component 80.

When a user interacts with fields within a component 80 on a given page 84, any events that are triggered (e.g., clicking a button) are directed by the financial planning system 20 to the function object 82 (code) associated with the component 80 that contains the control that triggered the event (e.g., the button). Each event is mapped to an event handler within the function object 82. For example, when a button is clicked, that event is directed to an event handler that performs some action (e.g., invoking a report, performing a calculation and so on). When the page 84 itself is submitted for processing (either by navigating to a new page 84 or clicking “Save” or some other action requiring the page 84 to be posted to the financial planning system 20), the fields for each component 80 are processed by that component's function object 82. The function object 82 contains code to further validate the input text to ensure that it can be safely assigned to its underlying data object (e.g., family member records, addresses, assets, liabilities, income records and so on). The function object 82 performs more complex processing of the input field values (e.g., convert dates to ages and so on).

The components 80 and their associated JavaScript code and function objects 82 can be managed as a single entity. Further, the components 80 can be managed independent of what page 84 contains the component 80. Components 80 can be used with different page 84 and the financial planning system 20 handles routing of the controls and events associated with the component 80 to its corresponding function object 82 in the same manner, regardless of where the component 80 is located. When a page 84 containing three components 80 is posted to the presentation player 74, the presentation player 74 redirects the processing of the fields on the page 84 to three different function objects 82. Components 80 can be moved to any page 84 within any presentation and still function, with no additional coding. They can even be moved between a main page 84 and a pop-up window with no code changes, and their appearance (size, colors, fonts, etc.) is independent of how they are processed as well. Components 80 can be rendered with different style sheets without affecting their underlying behavior.

This modularization of components 80 enables the creation of presentations that can leverage these components 80 to collect data, perform the analysis and render output results without writing any new code.

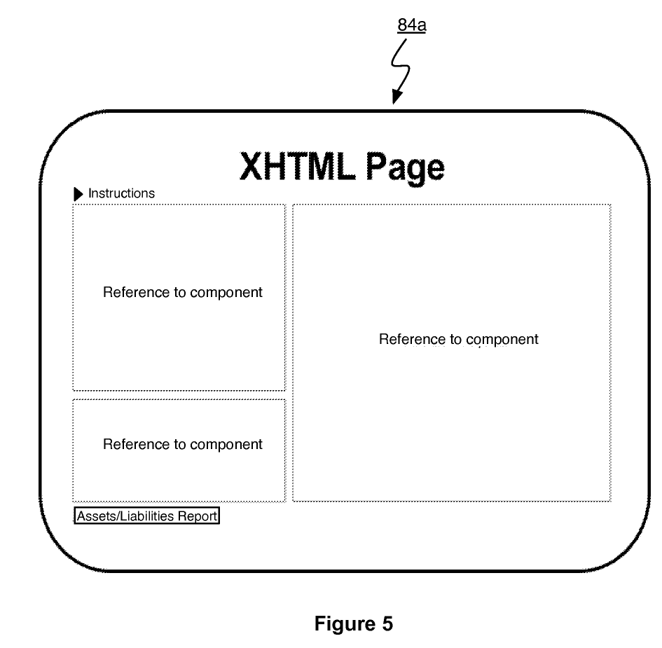

FIG. 5 shows a page 84a representing the requested user interface page in the financial advisor interface 68. It references several components.

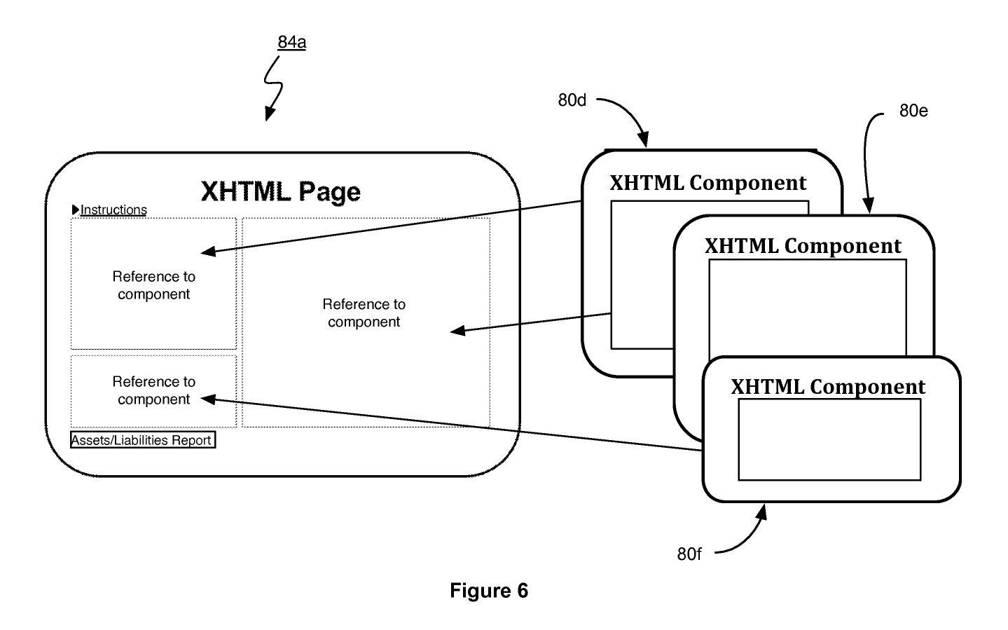

FIG. 6 illustrates the components 80d, 80e and 80f referenced in the page 84a being merged into the HTML of the page 84a that will be returned to the browser.

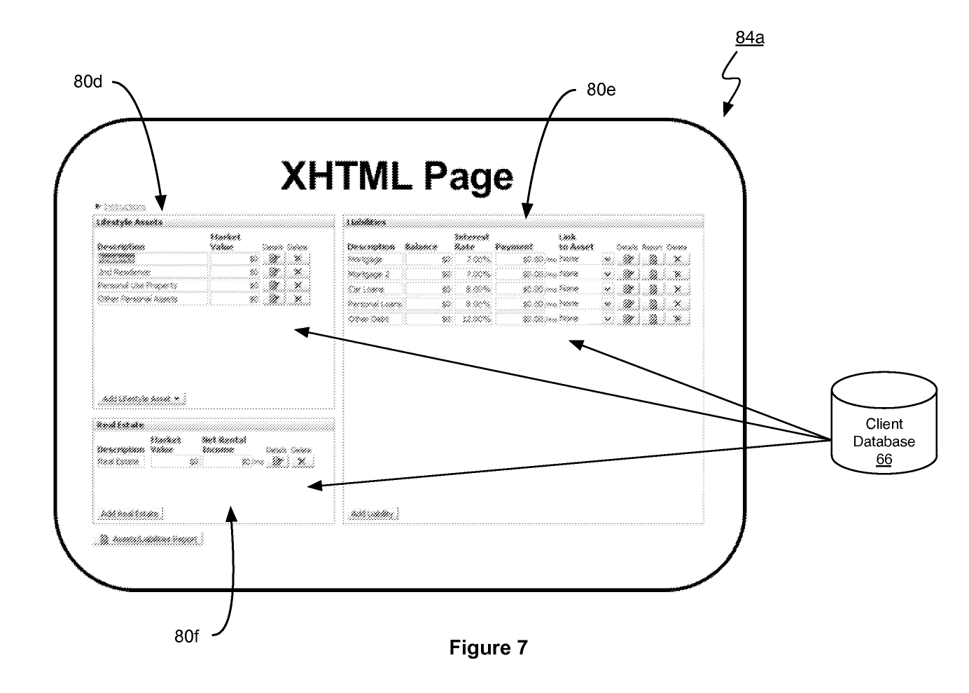

FIG. 7 shows client data from the client database 66 being used to populate the component field values of the components 80d, 80e and 80f. The data is obtained during generation of the page 84a by the financial advisor interface 68, wherein, upon recognition that a component 80 is being injected into the page 84a, it calls the financial planning engine 64 with a reference to the function object 82 corresponding to each component 80d, 80e, 80f and asks the financial planning engine 64 to provide the values for each of the fields in the components 80d, 80e, 80f. In turn, the financial planning engine 64 queries the client database 66 to obtain the requisite data. In the case of tables, values are queried for each field in each row of the table.

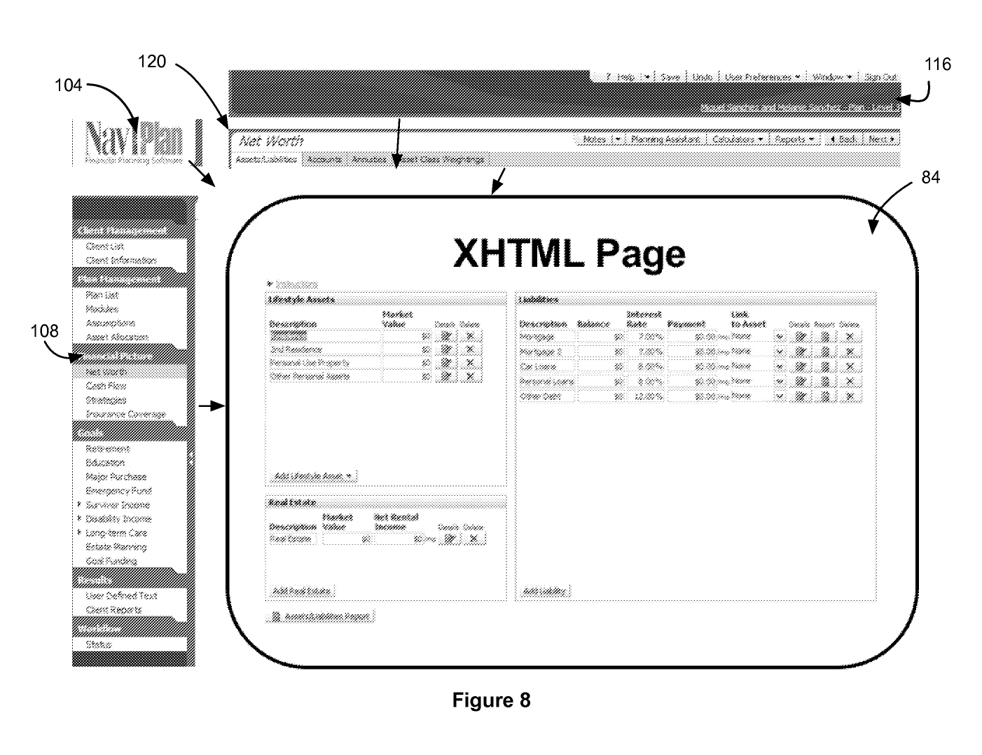

FIG. 8 illustrates the actual assembly of a screen of the financial advisor interface 68. The logo area 104, the navigation menu 108, the banner 116 and the tabs 120 are merged with the HTML of the page 84 to complete the screen. The final composite page of HTML is returned by the financial advisor interface 68 to the browser.

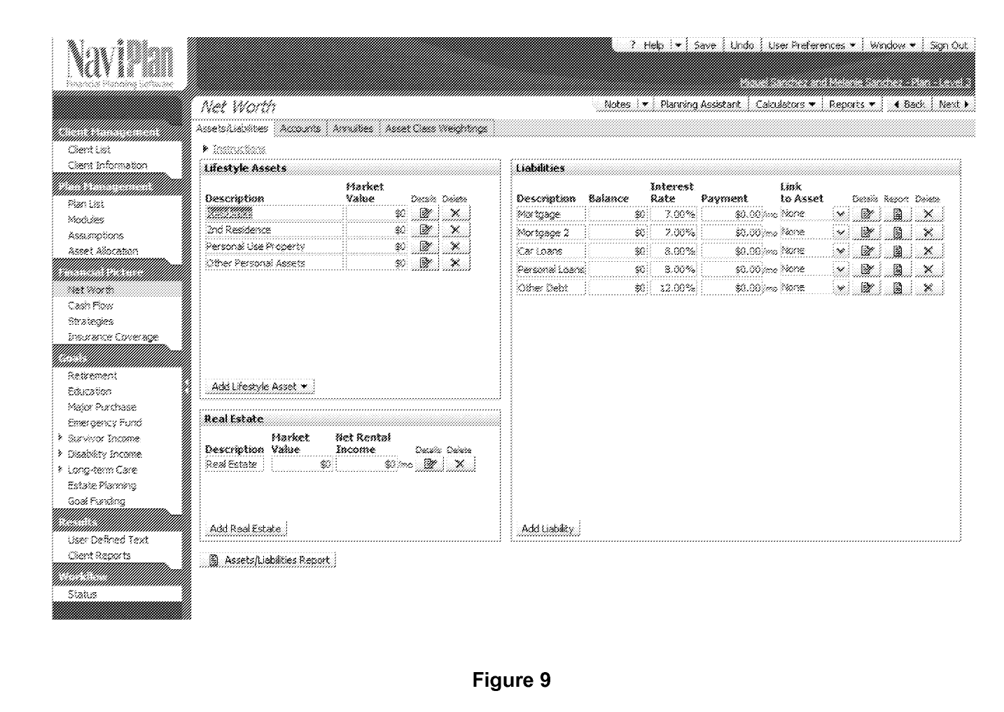

FIG. 9 shows the completed screen generated by the financial advisor interface 68.

### Presentation Module

The functionality of the presentation editor 72 allows a user (usually an editor appointed by a financial institution's head office) to quickly create presentations and deploy them out to users. This is achieved without having to do any coding and with minimal testing, as no new code is being introduced and the components 80 and pre-defined slide layouts 88 have already been tested.

Presentations provide a customizable user interface for interacting with the financial planning engine 64 that allows a user to enter input data, have the financial planning engine 64 process that data as well as other data in the client database 66 and present financial planning results back to the user.

The presentation module 70 leverages the technical architecture of the financial advisor interface 68 to make it possible to quickly and accurately create new dynamic user interfaces for a particular purpose that can be used as alternative interfaces to the financial planning engine 64. What the user experiences is something similar to “playing” a presentation, except that the slides of the presentation leverage all the power and sophistication of the underlying financial planning engine 64 to allow the user to enter input data in a specific sequence or structure for the particular purpose and see the results of calculations performed using that data.

The manner in which a user interacts with the financial planning engine 64 when using the presentation player 74 differs from how the user would interact with the financial advisor interface 68. With the presentation player 74, the process can be much more structured and follow a pre-defined set of steps. The user typically starts on a simple “landing page” (further described below), selects a client and plan (or opens an existing one), selects a presentation from a list of available presentations and then steps through the slides of the presentation.

The simple, step-by-step process offered by the presentation module 70 has been designed to make interacting with the financial planning engine 64 as simple as possible, so that new users of the financial planning engine 64 can get up and running quickly and easily. With the presentation module 70, there are few choices that the user needs to make and the flow through the interface can be fairly linear. This is in contrast to the financial advisor interface 68 where the user is provided a much wider array of options and choices and can move around the application in a variety of ways.

As mentioned above, the first slide that a user typically sees upon opening the presentation player 74 is called the landing page.

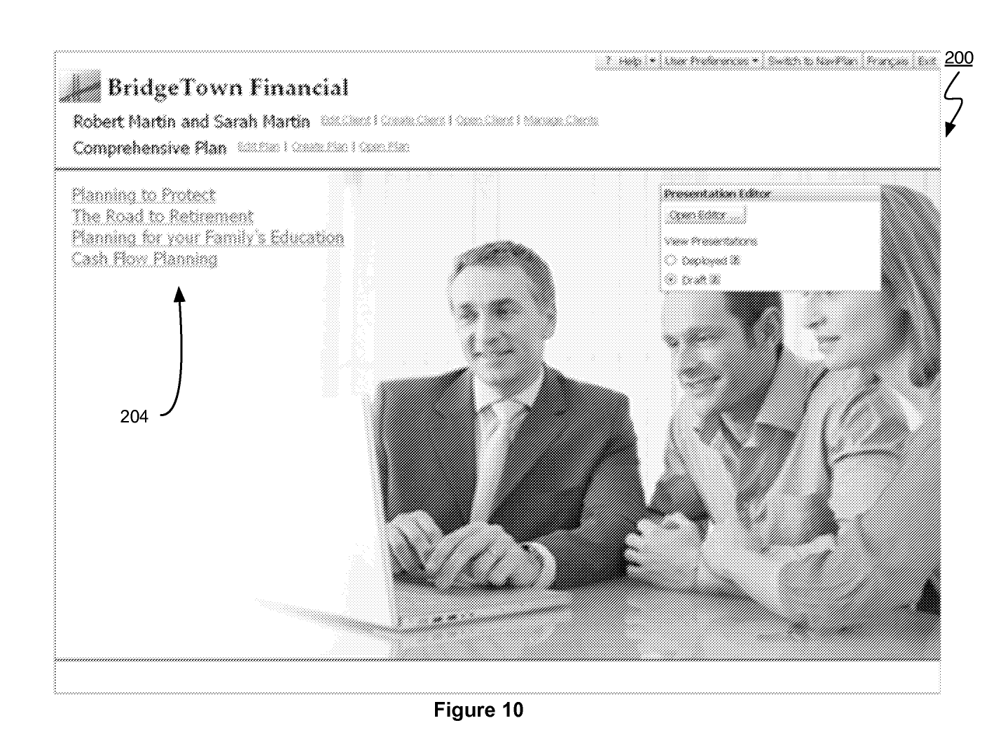

FIG. 10 shows an exemplary landing page 200. On this landing page 200, the user must open a client and plan to work with, or create a new client and plan, and then select a presentation to play. Creating a new client and plan is similar to playing a presentation, in that the user is taken through a series of slides in which they can enter client data and start a new plan. At that point, the user is returned to the landing page 200 to select what presentation to play from a presentation list 204. The user can select a presentation based on what type of financial planning they want to perform for the client. Note that the user can also be the client.

For example, if the client is in need of advice related to life insurance, the user might select the “Planning to Protect” presentation from the presentation list 204. This will tell the presentation player 74 to launch the presentation by displaying the opening slide of the presentation. From that point, the user can navigate through the slides of the presentation or return back to the landing page 200 to select another presentation.

A financial planning presentation, like a presentation in other applications, consists of a series of slides.

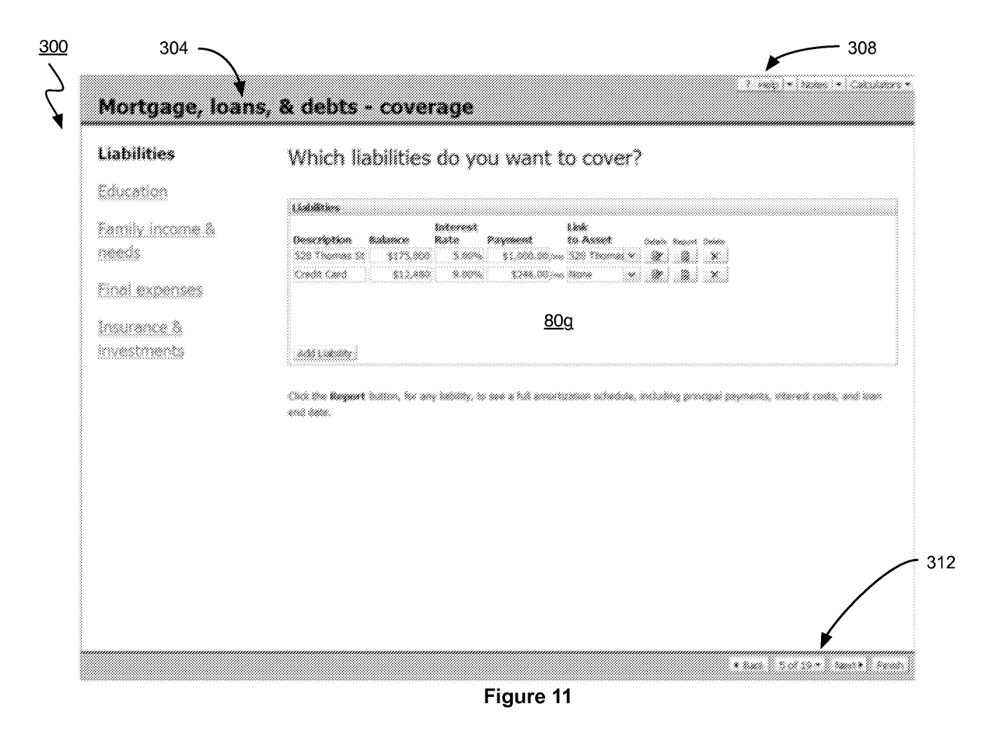

FIG. 11 shows a typical slide 300. Although the presentation module 70 supports a variety of slide layouts (title slides, one component slides, two component slides, etc.), a typical slide contains a title 304, a help button 308 and a navigation bar 312 containing navigation buttons to move from one slide to the previous or next slide, or to a specific slide, or finish the presentation. In most cases, slides contain additional static text and/or images and, in some cases, slides contain one or more input components and output components 80. In a sense, a slide contains equivalent elements to a page in the financial advisor interface 68. Note that a “Liabilities” component 80g shown on the slide is the exact same “Liabilities” component 80c as exposed in the screen 100 generated by the financial advisor interface 68 and shown in FIG. 4. The fields of the component 80g have been rendered at a different size to look more consistent with the concept of a presentation slide.

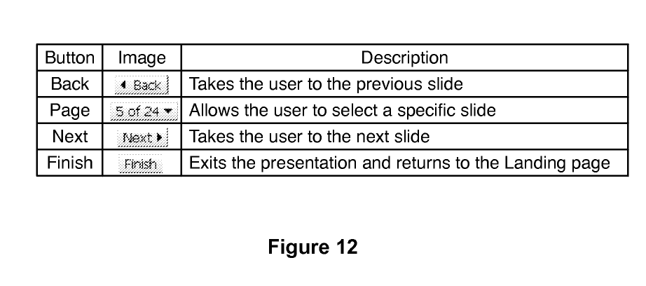

A table of the various buttons on the navigation bar 312 and their functions is shown in FIG. 12. Navigating from slide to slide in a presentation is as simple as clicking the “Back” and “Next” buttons in the navigation bar in the bottom right corner of each slide. Users can also select a specific page from a “Page” button or click a “Finish” button on the navigation bar 312 to complete a presentation and return to the landing page 200.

Slides can also be designed with hyperlinks that take the user to a specific slide or launch an external Web page in a new window.

Navigation is handled as an event that is processed by the presentation player 74. When a navigation event is encountered, such as the event associated with clicking the “Next” or “Previous” buttons of the navigation bar 312, the presentation player 74 recognizes that the user has asked for a different slide to be rendered. The current slide is processed (inputs collected) and the requested slide is generated and returned to the browser.

In some cases, the user may navigate away from a particular presentation and return to the landing page 200. Alternatively, the user may be on the landing page 200 and select a specific presentation. In either case, the presentation player 74 recognizes which slide has been requested and processes the slide contents and returns them to the browser to render for the user.

### Slide Construction

The slide construction process using the presentation module 70 is very similar to the process used to generate a screen in the financial advisor interface 68.

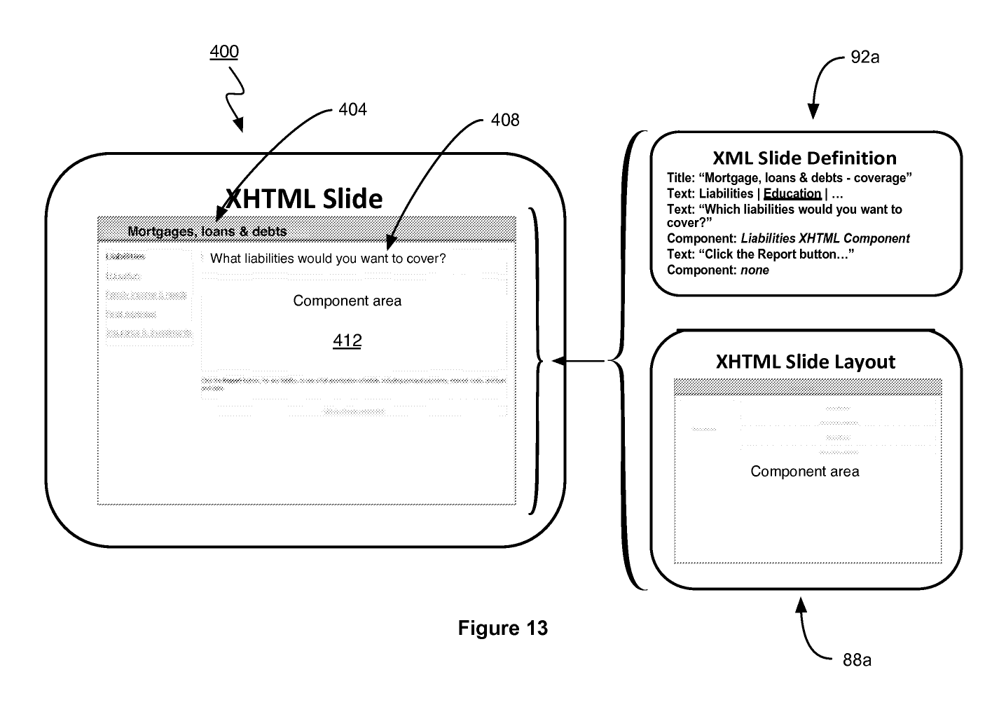

FIG. 13 illustrates an early stage of construction of a slide 400 of a presentation. An extensible markup language (“XML”) slide definition 92a is loaded. The slide definition 92a specifies a slide layout 88a and what is to be injected into the various areas of the slide layout 88a. The particular slide layout 88a specified has a title area, a text area and a component area. The slide definition 92a specifies what is to be placed in each of these areas. The slide 400 is shown after being populated with a title 404 and static text 408. A component reference 412 is still unpopulated.

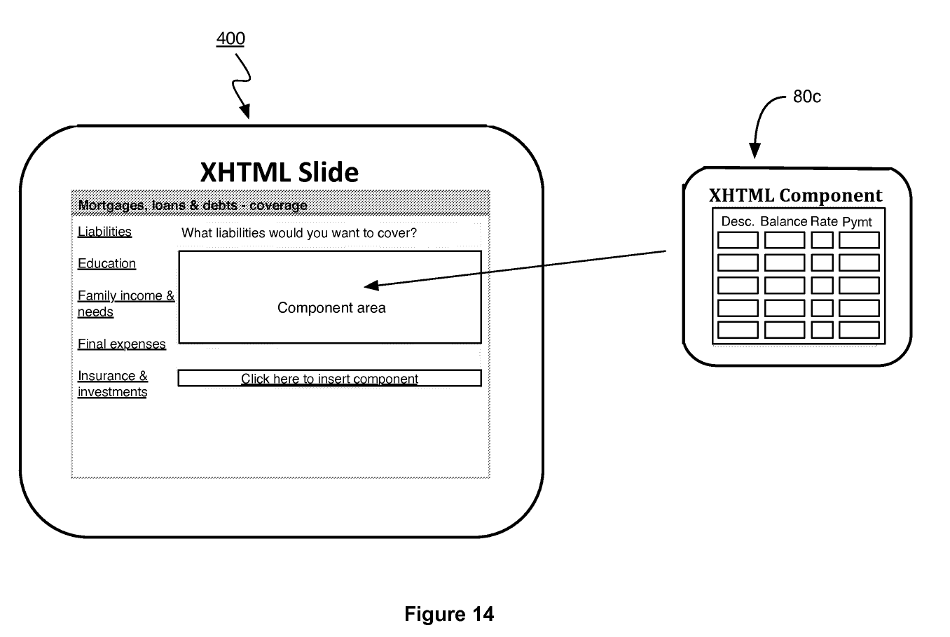

As shown in FIG. 14, the component 80c referenced in the slide definition 92a is merged into the XHTML of the slide 400. Note that this is the same component 80 that was used by the financial advisor interface 68 on the “Net Worth” page shown in FIG. 4. The same function object 82 and JavaScript associated with the component 80c that was used in the financial advisor interface 68 are leveraged here to generate and process the component 80c on this slide. The only difference is at the presentation player 74, where a slightly different style sheet is used to render the component 80c on the page to make it look more consistent with the appearance of a slide. A style sheet is a form of separation of form and content that stores and applies formatting to text and/or objects. All of the other properties and behaviors associated with the component 80c (mapping to data fields, field validation, events, etc.) are identical and share the same underlying code.

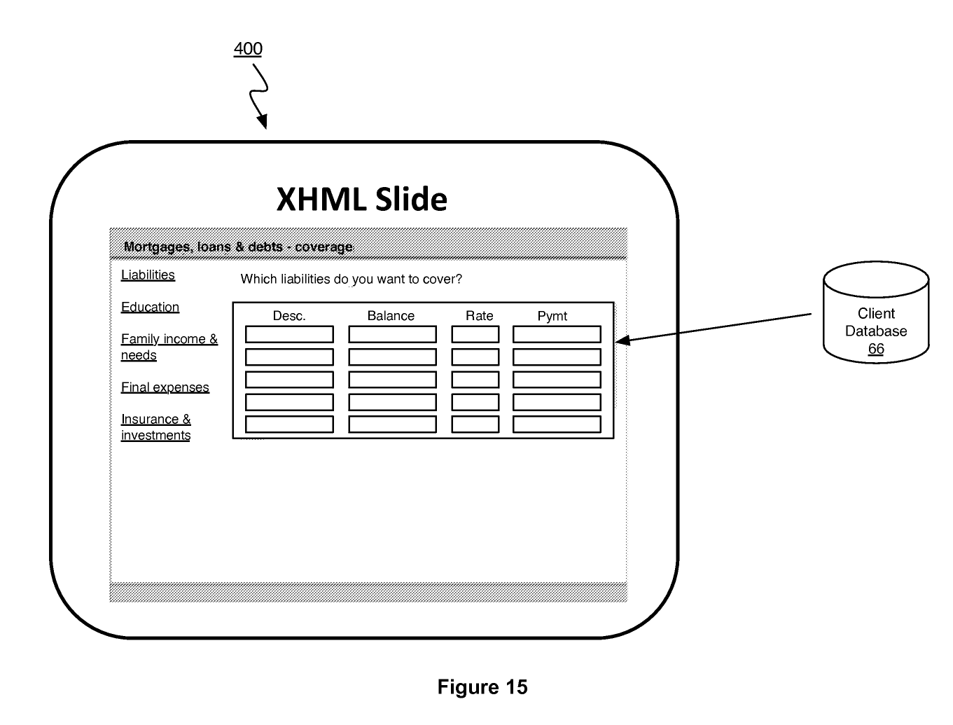

FIG. 15 shows data from the client database 66 being used to populate the component field values of the component 80c in slide 400. The presentation player 74 calls the function object 82 associated with the component 80c, which, in turn, directs the presentation player 74 to retrieve the appropriate data from the client database 66. It then inserts the retrieved data in the appropriate fields.

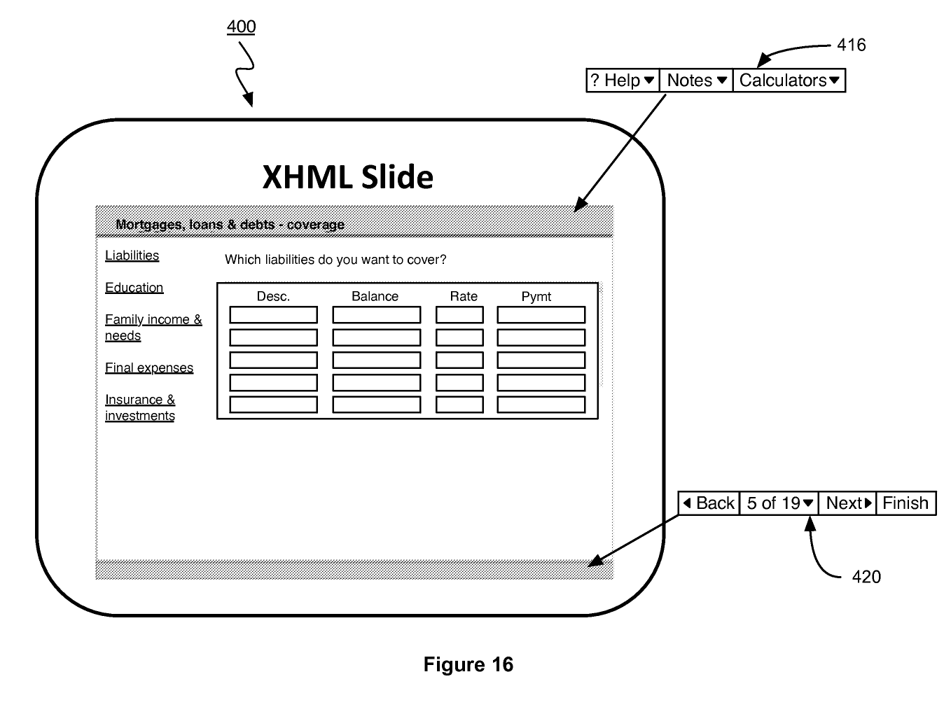

FIG. 16 shows the injection of a “Help” menu 416 and navigation buttons 420 into the slide 400 by the presentation player 74.

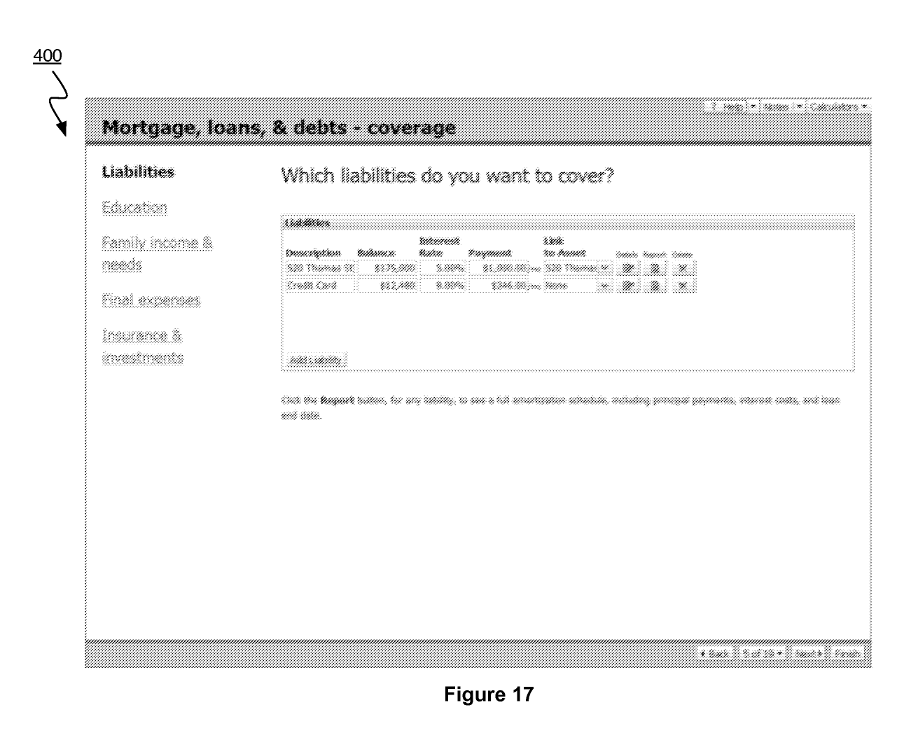

FIG. 17 illustrates the final composite slide 400 that is returned to the browser by the presentation player 74.

### Input Processing

Once a specific slide, such as slide 400, is generated by the presentation player 74 and delivered to the browser, the browser displays the static elements of the slide 400 such as text and graphics and displays controls representing the input elements (fields, tables, buttons, sliders, etc.) of the component 80c.

When a user clicks a button to navigate to a new page or “finish” the presentation, the browser records this as an event and then submits or posts the slide to the financial planning system 20 via the presentation player 74. Submitting a slide consists of sending the presentation player 74 the names of all input fields along with their values (i.e. name/value pairs), but may also be sending only that information that has been modified and the associated field names. The presentation player 74 then processes the input fields and maps their values to the corresponding function objects 82 which, in turn, assign the inputs to their corresponding data entities within a financial plan prepared for the particular client that is saved in the client database 66, if so required.

As controls such as input fields are organized into components 80 and the processing of the controls in a particular component 80 is handled by the function object 82 associated with that component 80, the presentation module 70 maps controls to their respective function objects 82. This is done using control names that indicate the components 80 responsible for each control. In the case of multiple components 80 on a page, each control of each component 80 is processed by that component's function object 82.

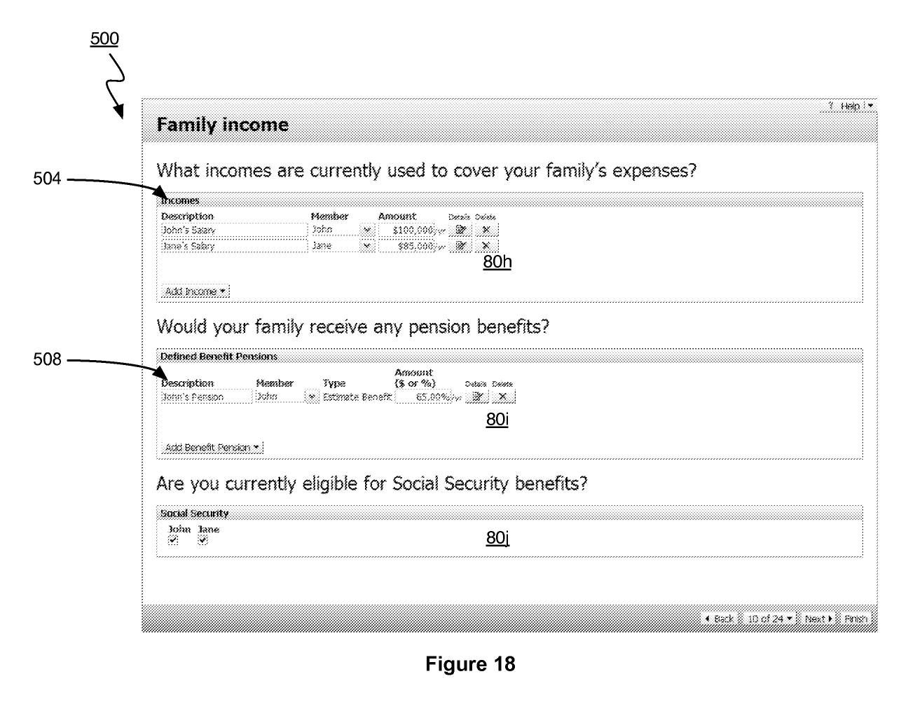

FIG. 18 shows a slide 500 containing multiple components 80h, 80i and 80j. Each component 80h, 80i, 80j contains either a table or other input fields. The presentation module 70 maps the fields in each component to its corresponding function object 82. This is done using the names assigned to the fields in XHTML. For example, the top two components 80h, 80i both contain tables and the rows of the tables both contain a “Description” field, 504 and 508 respectively. The presentation player 74 distinguishes between the “Description” field 504 for the Incomes component and the “Description” field 508 for the Defined Benefit Pensions component using a naming convention.

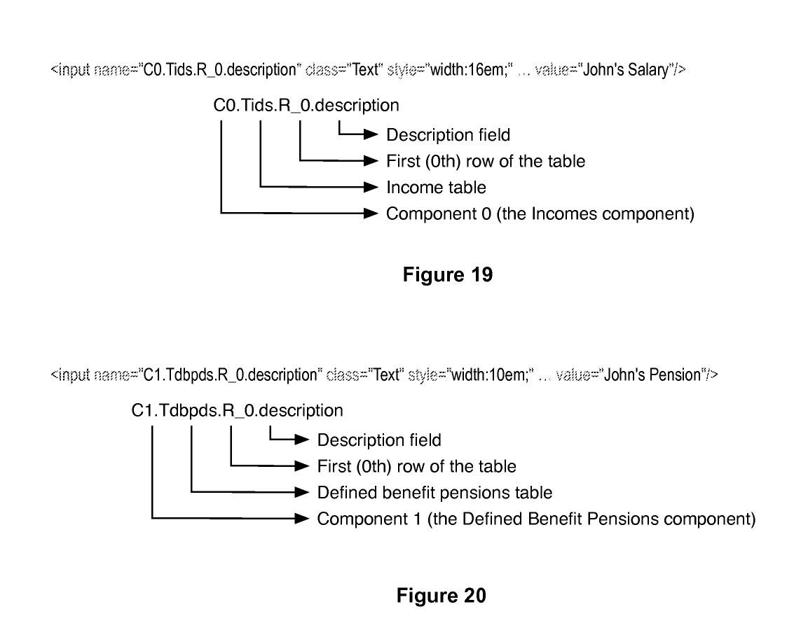

FIGS. 19 and 20 illustrate the naming convention employed by the presentation module 70 to distinguish between the two “Description” fields 504 and 508 respectively. In this example, the description fields 504 and 508 are generated by the presentation player 74 and named using object-oriented programming conventions.

Using these field names, the presentation player 74 can pass along the input fields to each of the components' function objects 82, which can, in turn, map each of the fields to their corresponding records within a plan in the client database 66. Thus, the field “C0.Tids.R_{—}0.description” is passed to the function object 82 for the Incomes component 80, which maps the field's value to the first income record's description.

Note that the field names are generated dynamically by the presentation player 74 itself to be unique within a given slide. As the presentation player 74 processes a slide for rendering, it generates field names that map each field to its corresponding component, table, row and data item as needed. Then, when the slide is submitted back to the presentation player 74, it can map each field's values back to its corresponding data entity. This is completely independent of what slide (HTML page) is hosting a particular component 80 (and its fields). Thus, a component 80 can be processed from virtually any slide generated by the presentation player 74.

The same holds true with respect to validating the field values. Rudimentary field validation is possible on fields in a fairly generic way using standard JavaScript such as ensuring numeric fields contain a number or date fields contain a date or that a field's values are within a specific range. More robust validation occurs when fields are posted back to the financial planning engine 64. When those fields are mapped from their component 80 to its corresponding function object 82, the function object code can perform more complex validation of the values. For example, the financial planning engine 64 can use the logic in a function object 82 to ensure that the retirement date for a person is reasonable (not before their birthday for example). Again, as this validation is executed by the function object 82 associated with a component 80, the validation is performed independent of what page contains the component 80.

Processing inputs and mapping them to their corresponding data elements within a client or plan is how data is collected. Events direct the presentation module 70 to take action on that data. For example, clicking the “Next” button on a slide causes the browser to transmit the data entered on the current slide to the presentation player 74 executing on the financial planning system 20, which generates the next slide in the presentation and returns it to the browser.

Events are handled in a manner that is similar to input fields. Each slide definition 92 has a set of hidden input fields. These fields can be assigned a value by JavaScript code but aren't visible on the page (the user cannot access these fields). Events are represented by a hidden field named “evt”. The value assigned to this field is determined by the action taken by the user on the page. For example, when the Next button is clicked, the value “evt_next” is assigned to the “evt” field and the page is posted to the application. The presentation player 74 then processes all of the input fields, mapping data from component fields to their respective data entities and then processing special fields, like the “evt” field to determine what event took place. In the case where the “evt” field has the value “evt_next”, the presentation module 70 knows that the user clicked the “Next” button and wants to navigate to the next slide in the presentation. Therefore, the presentation player 74 responds back to the browser with a rendering of the next slide in the presentation. If the user clicked the “Finish” button, then the “evt” field would be assigned a value of “evt_finish” and the presentation player 74 would know to take the user back to the list of presentations by rendering the landing page.

Note that if an issue was encountered when processing the form fields (e.g., a field's value was found to be in error), then the event is ignored and the current slide's XHTML is returned to the browser, typically with additional markup to show which field was in error. Otherwise, the event will be processed.

Of course, there are many other events other than events to navigate from slide to slide. Components 80 often define their own set of events that they will process themselves. For example, the Details buttons in the Income and Defined Benefit Pensions tables set events that are processed by their corresponding function objects 82. The slide is posted (to ensure that the current inputs are collected) and then the function object 82 processes the event itself by telling the engine to render a pop-up that displays details on that particular row's record. The slide that is returned includes an HTML DIV element containing the input fields for editing the details of the specific record, which is displayed to the user in the form of a pop-up window.

In some cases, events are handled not by posting the entire slide but by executing an Asynchronous JavaScript and XML (“AJAX”) request to the presentation player 74. In these types of requests, the event is handled by posting a small set of data to the presentation player 74 asynchronously while keeping the current page in memory. Typically, the response to the call is processed by a handler that updates the current page contents (assigns field values, adds more fields or modifies the contents in some other way). For example, on the Family Income slide shown in FIG. 18, the Income component includes a menu button called “Add Income” for adding a new income record. This button drops down a list of income types (e.g., Salary, Bonus, etc.). Each one of these entries triggers a specific event to insert a particular income type into the Income table. In this case, the events are handled by making an AJAX call to the presentation player 74. In the AJAX call, the value associated with that specific component 80 and button menu option is passed to the presentation player 74. The presentation player 74 recognizes that this AJAX call is for a particular component 80 and passes the request to a special handler for that component 80. In this case, the component's function object 82 handles the “Add Income” request by generating the fields necessary to add a new row in the table, which represents the specific type of income record specified by the menu item. These new fields are returned in the response to the AJAX call and a JavaScript handler merges these new fields into the HTML for the slide, thereby adding the new income record to the table that is displayed to the user.

Other events may navigate the user to a specific slide, or invoke a new window that displays an external HTML page to the user, or take the user to an external application.

### Calculations

The calculations to be presented via those components 80 that show results are often performed implicitly when navigating to a new slide. If the contents of the slide include what are called “output components”, then the presentation player 74 typically requests the results of calculations to be performed by the financial planning engine 64 on the input data to generate these output components.

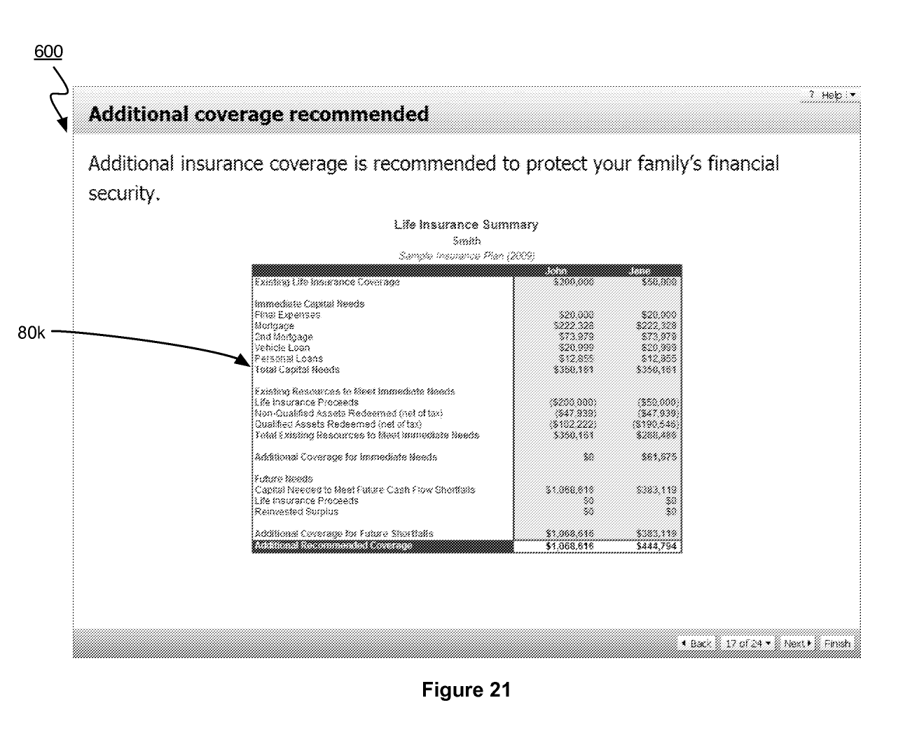

FIG. 21 illustrates a slide 600 containing such an output component 80k. The output component 80k is a table generated by performing calculations on the plan. This table is added to the slide 600 during generation of the slide 600 by the presentation player 74. That is, the content of the output component 80k is generated by the presentation player 74 by requesting the results of calculations to be performed by the financial planning engine 64 using data stored in the client database 66 (and generally provided via data inputs from the presentation) and rendering HTML that is merged into the slide contents.

Therefore, simply by navigating to this slide 600, the user triggers the financial planning engine 64 to perform calculations on the planning data. Other types of output components 80 may be used. For example, results calculated by the financial planning engine 64 can also be rendered as graphs.

One subtle way to perform calculations and merge output onto a slide is to use what are called “tags” to merge calculated results into the text displayed on a slide.

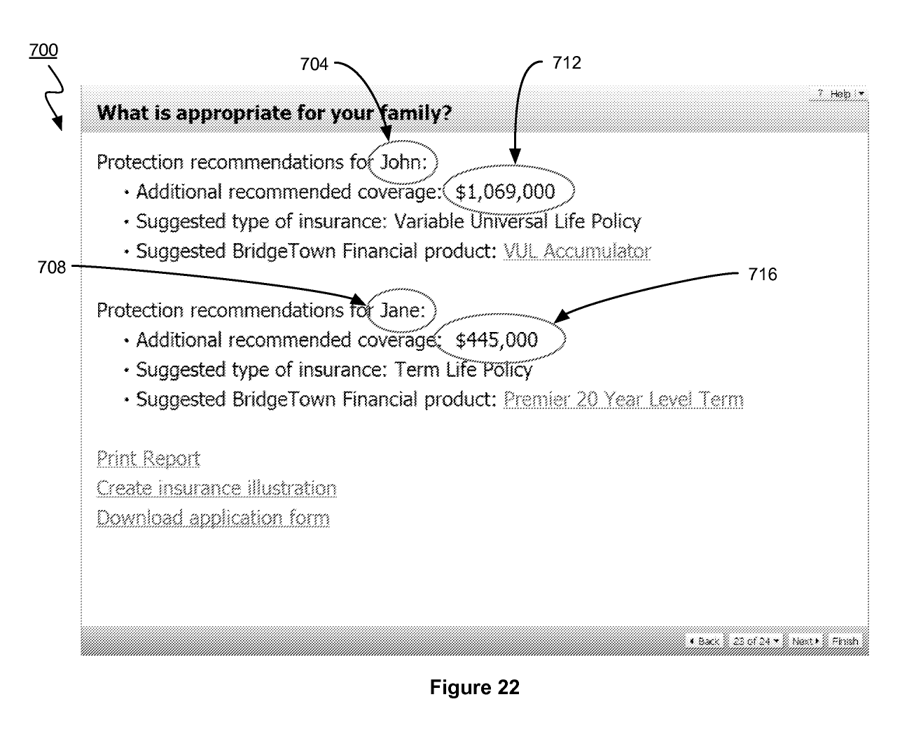

FIG. 22 shows a slide 700 illustrating the client's name 704 and the client's spouse's name 708, as well as client's recommended insurance coverage 712 and the client's spouse's recommended insurance coverage 716 in the text on the slide 700.

These values are generated by the financial planning engine 64 and inserted into the text on the slide 700 by the presentation player 74. This is done by defining the slide text with placeholders, or “tags” that tell the presentation player 74 to request a specific value from the financial planning engine 64 and insert it into the text. For example, in the above slide, the top section corresponds to the following XML generated by the presentation editor 74:
Protection recommendations for {ClientFirstName}:
   Additional recommended coverage: {LifeInsuranceAdditionalCoverageNeededHead1}
   Suggested type of insurance: Variable Universal Life Policy
   Suggested BridgeTown Financial product: VUL Accumulator

When the presentation player 74 renders the slide 700, it parses the text for the slide 700 (in the slide definition 92) and encounters the two tags “{ClientFirstName}” and “{LifeInsuranceAdditionalCoverageNeededHead1}”. These two tags tell the presentation player 74 to insert the value for the client's first name and then insert the calculated value for the additional life insurance coverage needed for the client. Thus, the presentation player 74 requests and retrieves the client's name and the additional life insurance value from the financial planning engine 64, and inserts those values generated by the financial planning engine 64 into the text that it returns to the browser.

Another way that calculations can be triggered by a slide is to include both input fields and output fields on the same slide and then add an event that submits the slide but leaves the user on that slide (i.e. refreshes the slide but doesn't navigate away). Assume that a particular slide contains some input fields, a graph and a button that simply submits the current slide but leaves the user on that specific slide. When the slide is submitted, the presentation player 74 processes the input fields and then responds to the event by regenerating and returning the current slide to the browser. Since the slide also contains an output component 80 (the graph), that output component 80 is generated (i.e. a new graph) and merged into the XHTML for the slide. The result is that when the user clicks the button, the slide is refreshed with a new graph showing the affect of the changes in the input values.

So, in summary, the functionality of the presentation player 74 is a whole new user interface on top of the financial planning engine 64 that allows a user to select from a set of presentations and then navigate through those presentations to collect input data and generate output results that can be displayed to the user/client, while at all times leveraging the power and strength of the underlying financial planning engine 64. The interface is simple and intuitive and mimics the process of running (or playing) a presentation.

This is done by leveraging the component-processing capabilities of the financial advisor interface 68 and rendering those components 80 onto slides (i.e. pages that look like a presentation slide) via the presentation editor 72. Because components 80 are used, the data collected in the presentation player 74 will match exactly what is collected by the financial advisor interface 68, and all of the same validation rules and processing are enforced by each component regardless of whether it is being presented in the presentation player 74 or the financial advisor interface 68. This ensures consistency and accuracy of the data collected and calculated results and significantly reduces the work needed to create the two interfaces (work done to create new components in one interface can be leveraged to create pages in the other interface).

### Presentation Editor

The presentation editor 72 allows non-technical users to create presentations in a very simple and easy-to-use manner and at a significantly-reduced effort and cost compared to the traditional techniques, which would require development and testing of new code for the creation of each new user interface and for each change made to the interface.

### Presentation Resources

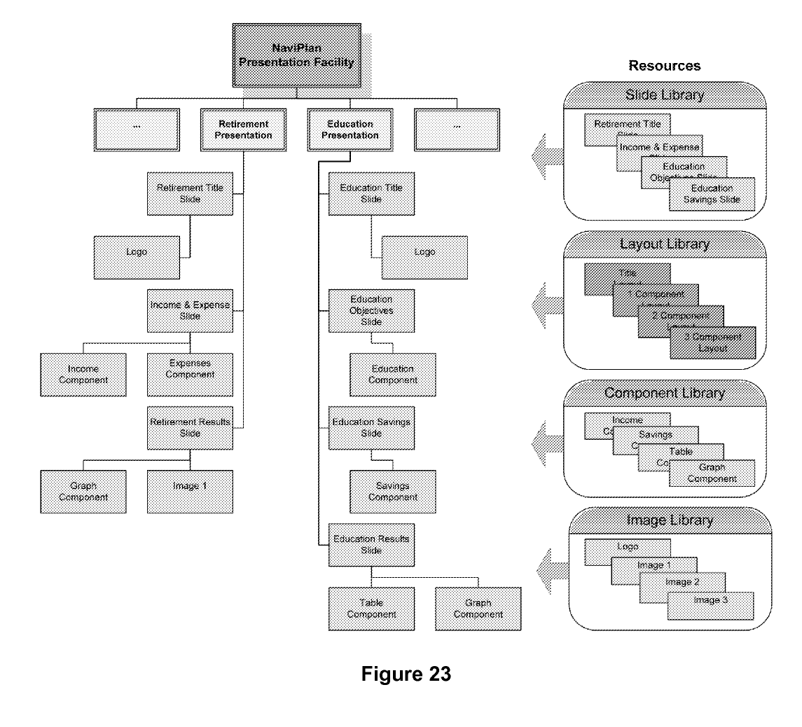

One or more presentations are represented within the financial planning system 20 as a set of interrelated resources as illustrated in FIG. 23. The presentation contains one or more slides that can include text, components, images, etc. Note that slides, components and images can be shared between multiple presentations. For example, if two presentations both need to gather income data, then the same income slide can be referenced in both presentations. In addition, more importantly, the income component 80 within the slide in both presentations will reference the same underlying data. So editing income data in one presentation will be identical to editing that same income data in the other presentations that share the income component 80. Further, clients can add to the slide and image libraries by creating new slides from slide layouts or importing new images.

In order to provide insight into how a presentation and its various resources 76 are defined with the presentation editor 72, the XML code defining these structures will now be discussed.

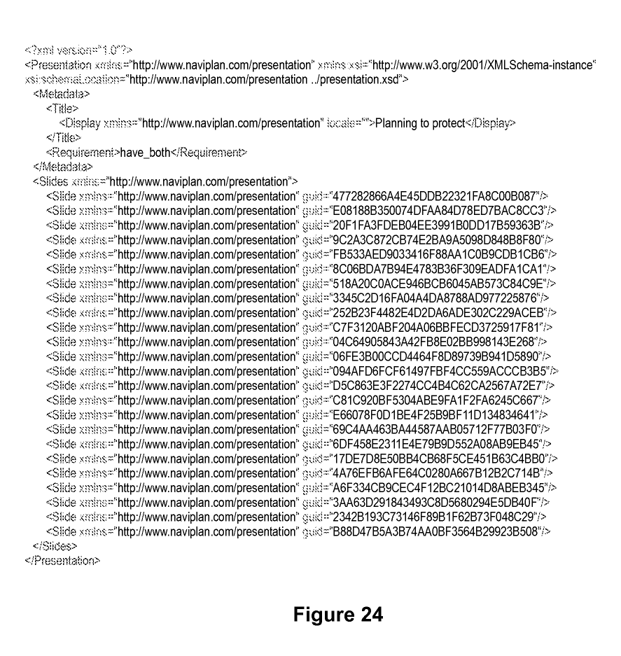

FIG. 24 shows the XML of a presentation definition 94 defined for an exemplary presentation. Note that, in the presentation definition 94, slide definitions 92 representing slides are defined using a “Slide” node that contains an xmlns namespace attribute and a guid attribute. A globally unique identifier, or “GUID”, is a special type of identifier used in software applications to provide a reference number, which is unique in any context (see http://en.wikipedia.org/wiki/Guid). In this case, the GUID uniquely identifies a slide in a slide library. This identifier is mapped to a corresponding slide definition 92, an XML file that defines the contents of the slide.

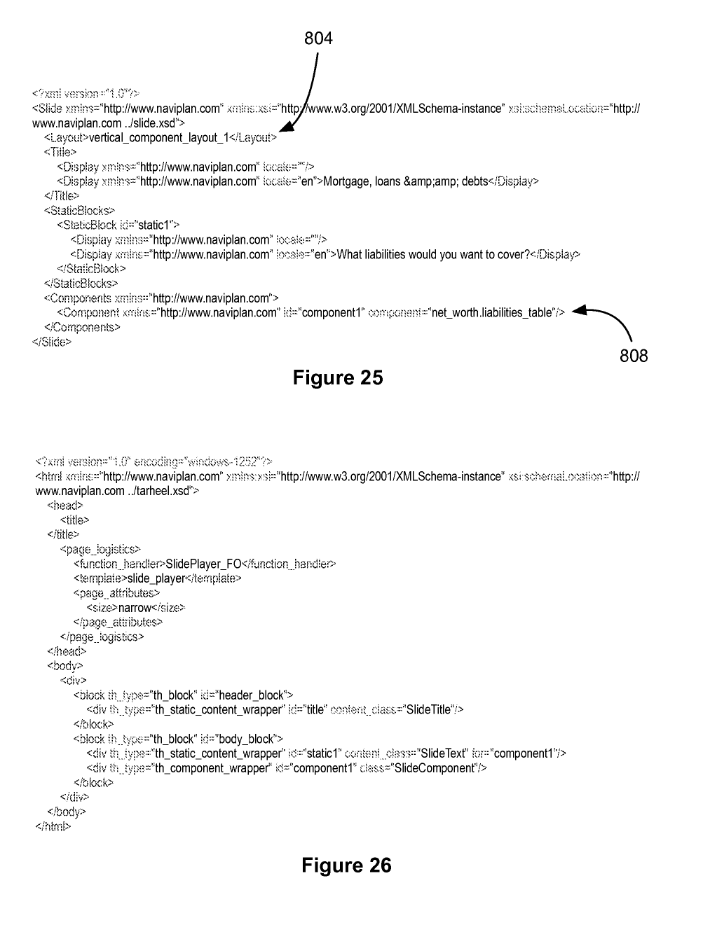

In this example, the GUID is mapped to a slide definition 92 containing the XML shown in FIG. 25. The XML in this exemplary slide definition 92 contains a reference 804 to a slide layout 88 (which defines how to lay out the content of the slide) and defines a title for the slide, some static content (text) and a reference 808 to a component 80. The slide layout 88 referenced is “vertical_component_layout_{—}1”. The reference 808 to the component 80 in the slide definition 92 shown in FIG. 25 identifies the component 80 named “net_worth.liabilities_table”. By following the instructions in the slide definition 92, the presentation player 74 can determine how to render the slide.

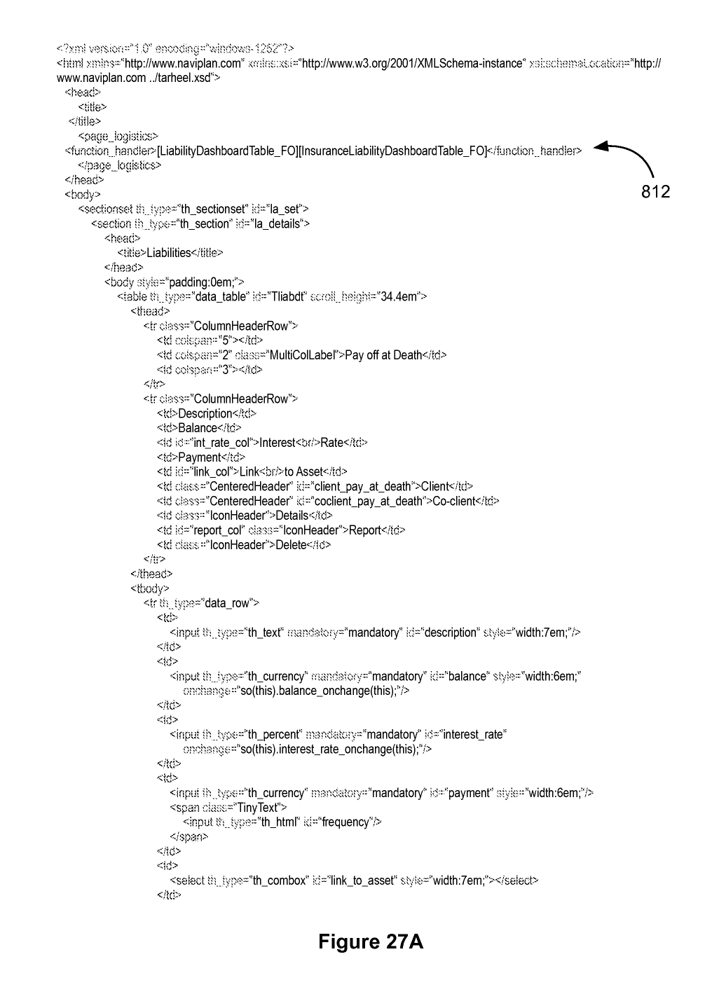

FIG. 26 shows the slide layout 88 referred to by reference 804 in the slide definition of FIG. 25. The slide layout 88 defines a title area, a static text area and an area for one component 80.

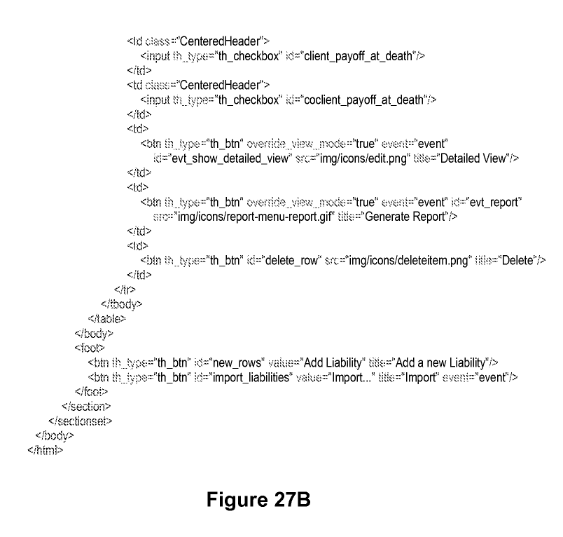

FIGS. 27A and 27B show the XML file for the component 80 named “net_worth.liabilities_table”. The XML defines how to render the Liabilities table component and its associated “Add” button. Further, it references the function object 82 used to implement the behavior of the component via a function handler node 812. Note that this same component is used by both the presentation player 74 and the financial advisor interface 68.

The presentation player 74 combines the XML information in the slide definition 92, the slide layout 88 and the component 80 and applies a cascading style sheet (“CSS”) definition to that information to render the actual slide.

The presentation editor 72 essentially provides a user interface that allows a non-technical user to generate and manage the presentation resources described above. When the user interacts with the presentation editor 72, the presentation editor 72 references existing resources, such as slide layouts 88, components 80 and previously-defined slide definitions 92 to create and modify presentation definitions 94 and slide definitions 92. Presentation definitions 94 and slide definitions 92 represent presentations and slides. New presentation definitions 94 and slide definitions 92 are stored as new XML resource files.

Note that only users given special permission within the presentation module 70 are allowed to create and edit presentation definitions 94 within the presentation editor 72. This role is typically only provided to a financial services firm's head office staff. Although the financial planning system 20 is initialized with a pre-defined set of presentation definitions 94, slide definitions 92, slide layouts 88, components 80 and images 90, the presentation editor 72 allows a user to create and manage presentation definitions 94 and slide definitions 92 to meet their specific needs. They can create presentation definitions 94 by leveraging the presentation definitions 94 and slide definitions 92 provided or create their own slide definitions 92 and presentation definitions 94. They do so by creating new slide definitions 92 that contain their own titles and static text or images and reference the existing components 80 and slide layouts 88 provided with the financial planning system 20 (they cannot create their own components 80 or slide layouts 88). They can then deploy these custom presentations out to their advisors who can then access the new presentations via the presentation player 74.

Before editing a presentation or creating a new presentation, the user first opens a mock client and plan using the presentation editor 72. This is done so that the presentation editor 72 can display the slides exactly as they would appear in the presentation player 74 with “real” data.

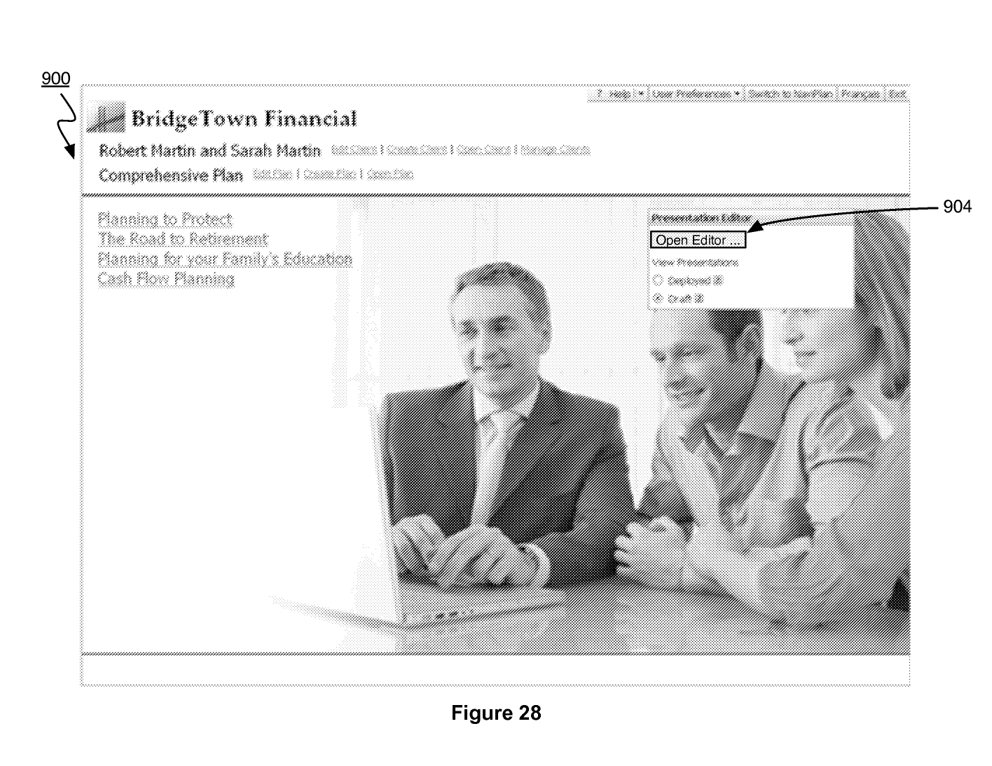

FIG. 28 shows a landing page 900 for a selected presentation within the presentation player 74. The user can invoke the presentation editor 72 by clicking the “Open Editor” button 904 from the landing page 900 of the presentation player 74 (the “Open Editor” button 904 is only available to users that are entitled to create/edit presentations).

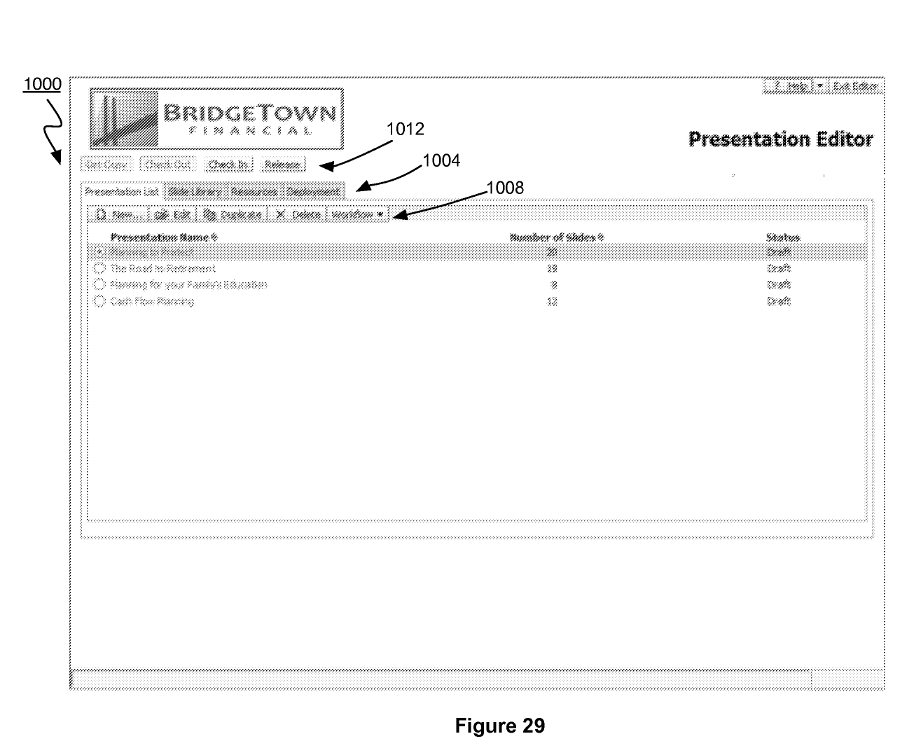

Clicking the “Open Editor” button 904 takes the user to a presentation editor screen such as the presentation editor screen 1000 shown in FIG. 29, which lists the available presentations. A set of editor tabs 1004 enables a user to switch between management of the presentations, shared slides and resources, and deployment of the presentations. The presentation editor screen 1000 shows that the presentation list button of the editor tabs 1004 is selected, and a list of presentations is shown. A set of presentation management buttons 1008 enables a user to create a new presentation, edit, duplicate or delete a selected presentation, and visit a workflow screen. A set of revision control buttons 1012 enables a user to check presentations out from the financial planning system 20 so that they can be edited without interfering with the live functionality of the financial planning system 20, and check presentations back into the financial planning system 20 so that they can be deployed into production (i.e., made available to users such as financial advisors).

All of the resources 76 (images 90, components 80, slide definitions 92, and presentation definitions 94) form a package of related presentation objects. Because the resources 76 can be shared across presentations, they are checked in and checked out together. Checking the resources 76 out (essentially grabbing an copy of the whole package) allows for edits to be applied and then for redeployment of the whole package (replace the old with the new copy) by checking the package back in. This check-out/check-in process is used to ensure that any modifications that need to be made to any of the resources 76 for changes made to another resource 76 are performed all at one time. It allows an organization to keep all of the resources 76 in synchronization and not require users to make individual changes that could conflict.

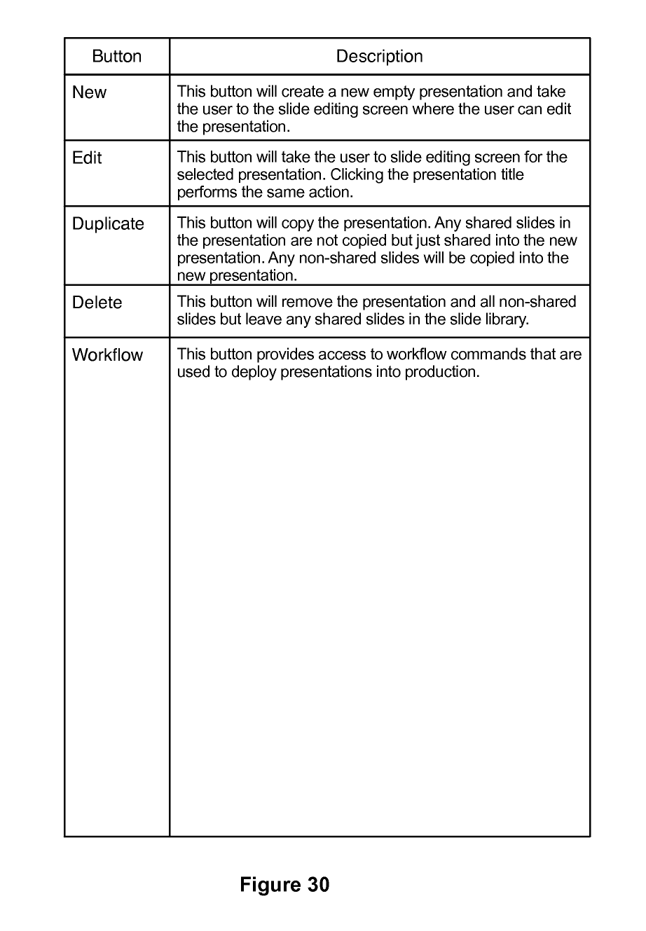

FIG. 30 shows a table of the presentation management buttons 1008 shown on the presentation management screen 1000 of FIG. 29 and their functions. The various presentation management buttons 1004 enable a user to create a new presentation, edit, duplicate or delete an existing one, and manage the workflow for the creation or editing of a presentation.

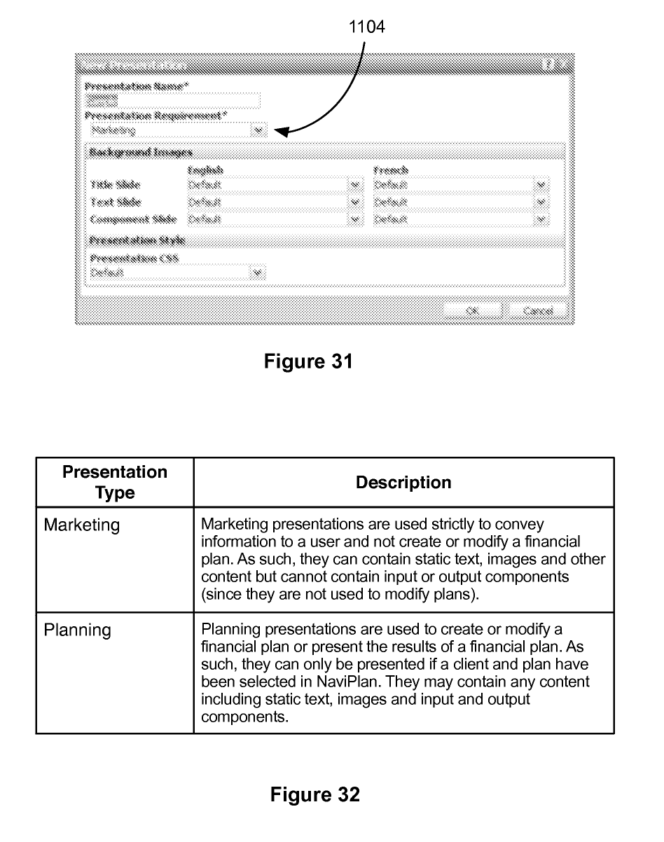

FIG. 31 shows a pop-up window presented by the presentation editor 72 upon activation of the “New” button of the presentation management buttons 1008 on the presentation editor screen 1000. The presentation editor 72 prompts the user to provide a name for the new presentation as well as the type of presentation to be generated. A type drop-down list 1104 allows the user to select the type of presentation being created. Additionally, the user can specify what background images are to be used for the presentation.

FIG. 32 is a table of the types of presentations available via the type drop-down list 1104 of FIG. 31 and their descriptions. A marketing presentation is intended to simply convey information to a client. It has no dynamic content in that it does not permit modification of the client data and does not require client data to be loaded. Further, a marketing presentation does not display any results from the financial planning engine 64. A planning presentation is used to create and modify a financial plan and, thus, accesses client data in the client database 66. It can have static content and dynamic content, enabling loading and modification of client data.

After completing this dialog, the presentation editor 72 will generate a new blank presentation containing no slides. The presentation definition 94 that represents the presentation is an XML file structured in a manner similar to the presentation definition shown in FIG. 24. A presentation editor screen of the presentation editor 72 displays an empty presentation.

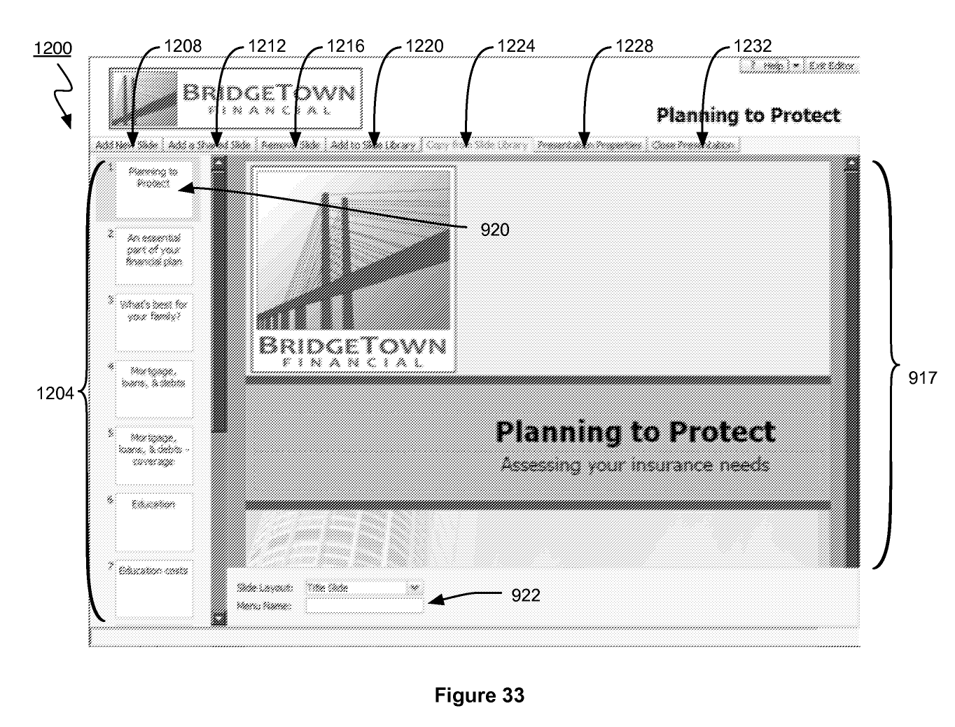

FIG. 33 shows a presentation editor screen 1200 of the presentation editor 72 with an existing presentation. Thumbnail images 1204 represent a number of existing slides in the presentation being edited. An “Add New Slide” button 1208 enables the creation of a new slide in the presentation. An “Add a Shared Slide” 1212 button enables insertion of an existing slide from the slide library into the presentation. A “Remove Slide” button 1216 enables the removal of a selected slide from the presentation being edited. If the slide being removed is a slide that is shared with other presentations, reference to the slide is removed from the presentation being edited. If, instead, the slide being removed is only used in the presentation being edited currently, then the slide is deleted altogether. An “Add to Slide Library” button 1220 enables a selected slide to be added to the slide library representing slides that can be shared by more than one presentation. A “Copy from Slide Library” button 1224 makes a copy of a shared slide in the slide library to be included in the presentation. By making a copy of a shared slide, editing of the slide does not affect the original shared slide used in other presentations. A “Presentation Properties” button 1228 enables the modification of the presentation name and type, as well as the background images and style sheet. The “Close Presentation” button 1232 saves and closes the presentation being edited.

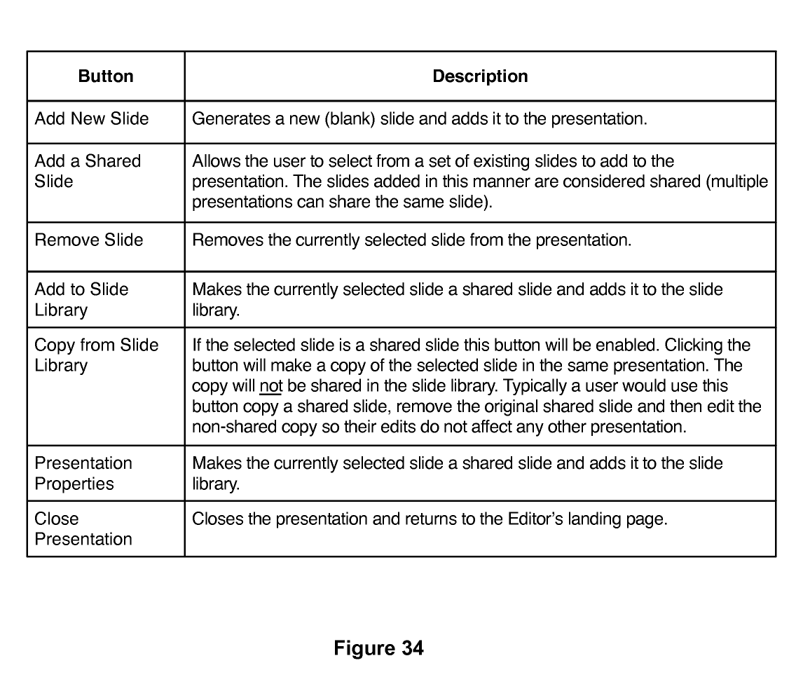

FIG. 34 shows a table of the buttons 1208 to 1232 on the presentation editor screen 1200 and their functions.

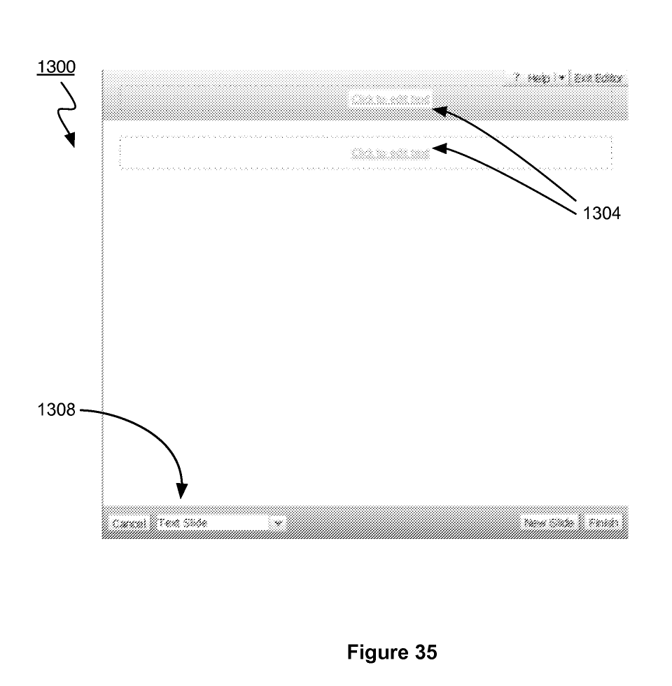

FIG. 35 illustrates a new empty slide 1300 generated in response to clicking on the “Add New Slide” button 1208. By default, the slide is laid out using a “Text Slide” slide layout 88 and includes two text areas 1304, a title area and a body text area. However, the user can use a “Layout” drop-down list 1308 to select the slide layout 88 to use for the new slide.

Users can select from the following slide layouts 88:
Title: A slide containing a background image, title text and subtitle text
Text: A slide containing a title and large text area; text can be richly formatted with colors, fonts, numbered and bulleted lists
One Component: A slide containing a title, text area and component area
Two Component: A slide containing a title, text area and two pairs of text areas and components
Three Component: A slide containing a title, text area and three pairs of text areas and components
Four Component: A slide containing a title, text area and four pairs of text areas and components
One Component with Sidebar: A slide containing a title, text area and component area, and a text area along the left side
Two Component with Sidebar: A slide containing a title, two pairs of text and component areas, and a text area along the left side
Three Component with Sidebar: A slide containing a title, three pairs of text and component areas, and a text area along the left side
Four Component with Sidebar: A slide containing a title, four pairs of text and component areas, and a text area along the left side
Horizontal Component: A slide containing a title and two components side-by-side
Horizontal Component 2: A slide containing a title, text area and two pairs of text and component areas side-by-side

Other slide layouts 88 may be defined for use with the financial planning system 20, but only the above-identified ones are included in the financial planning system 20 in the present embodiment.

As mentioned previously, each of these slide layouts 88 are pre-defined in XML files and provided with the financial planning system 20. A user can select which slide layout 88 to serve as a basis for a slide. When the user selects a slide layout 88, a reference to the slide layout 88 is added to the XML slide definition 92 and the user interface is modified to show the available areas for editing the slide according to the slide layout 88 selected.

When a new slide is created, the user can immediately begin editing the slide. Referring again to FIG. 33, for existing slides, the user can select the slide from the thumbnail images 1204 to begin editing the slide.

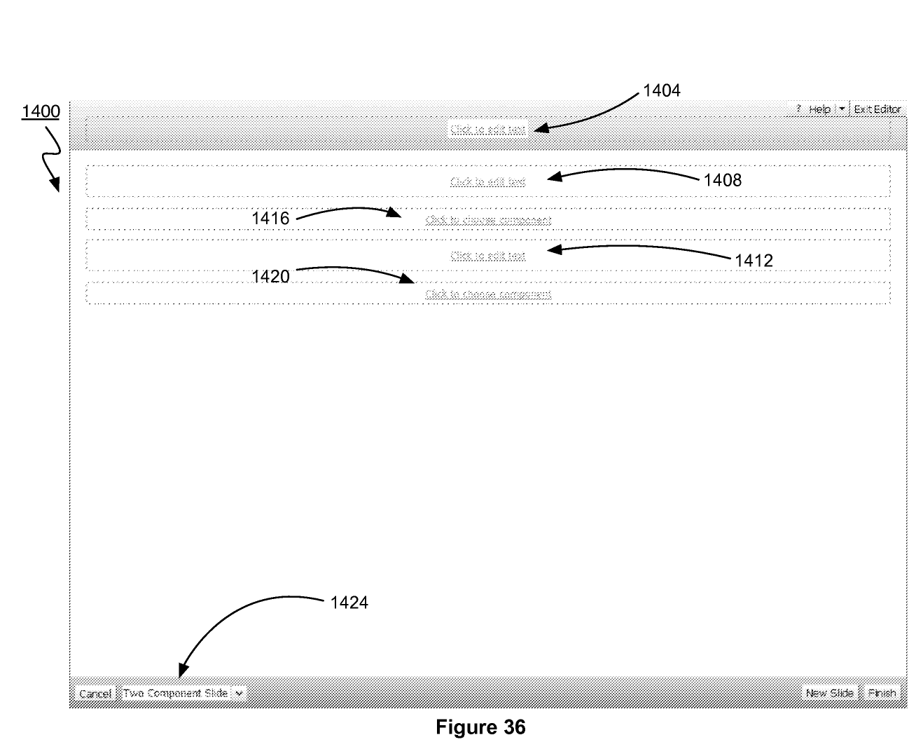

FIG. 36 shows another blank slide 1400. Depending on the slide layout 88 for the particular slide, the user will be able to modify the slide contents by clicking on editable areas of the slide 1400 (in this case, a title area 1404, other static text areas 1408 and 1412, and component areas 1416 and 1420). The title area 1404 and the other static text areas 1408, 1412 that can be edited are clearly indicated by a label that states, “Click to edit text” and the component areas 1416, 1420 are labeled “Click to choose component”. A “Layout” drop-down list 1424 similar to the “Layout” drop-down list 1308 enables selection of the slide layout 88 to use for the new slide 1400.

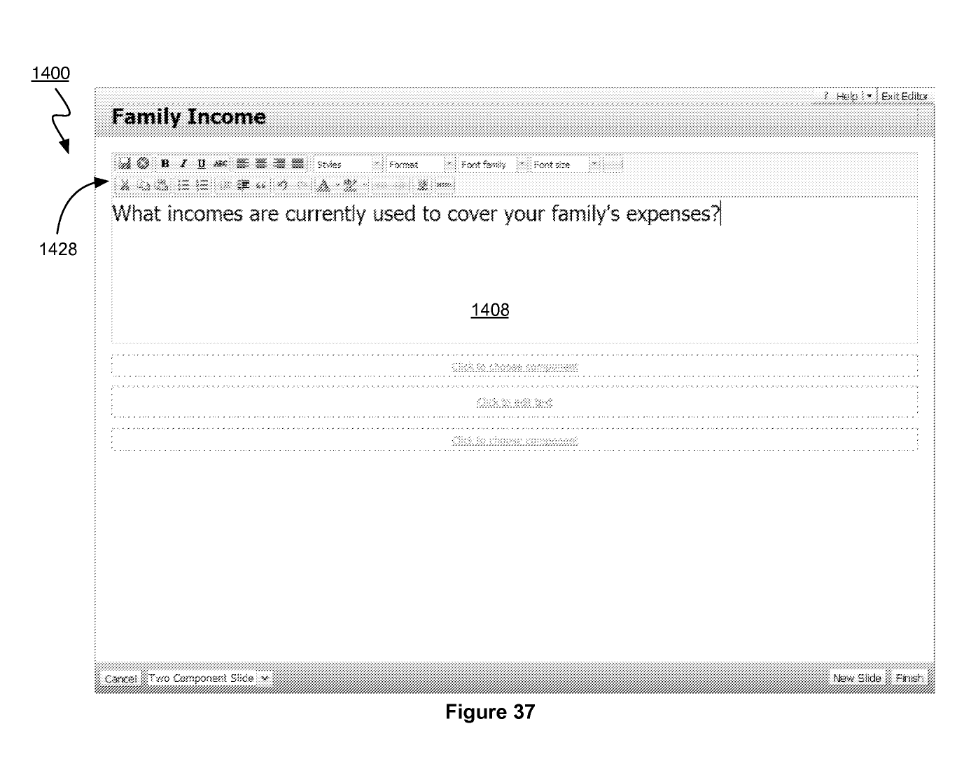

FIG. 37 shows the editing of the text area 1408 of the slide 1400 of FIG. 36. If the user clicks on the text area 1408, HTML editor controls 1428 are displayed enabling the user to format text entered into the text area 1408, including changing the font, size and color changes, as well as numbered or bulleted lists. Additionally, the HTML editor controls 1428 allow the user to insert links to Web pages, other slides and calculators.

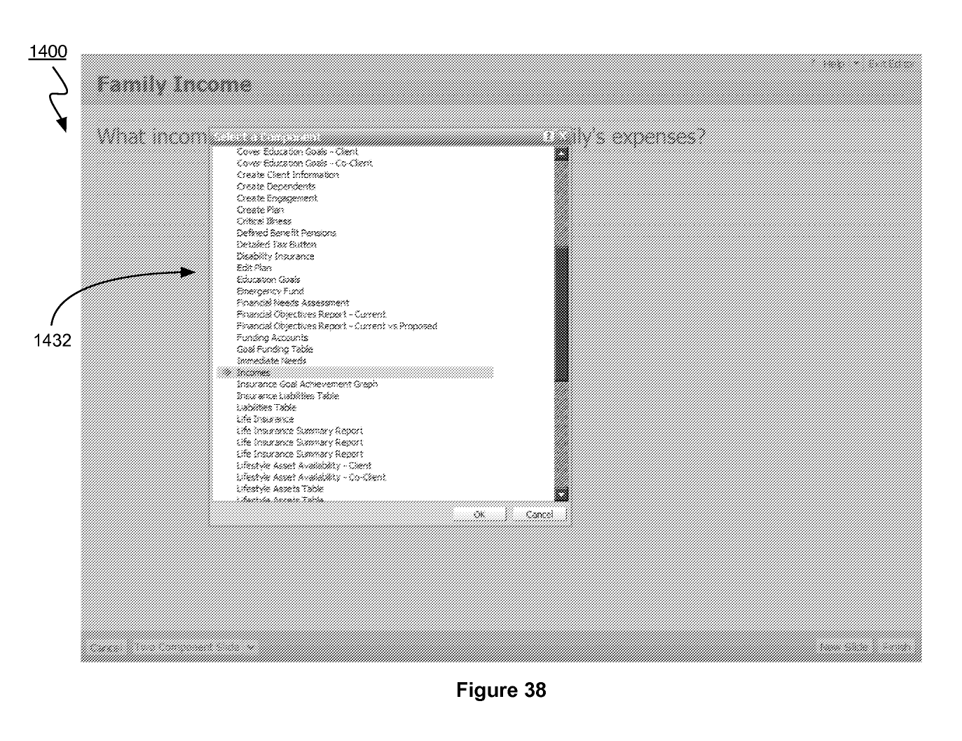

FIG. 38 shows the editing of the component area 1416 of the slide 1400 of FIG. 36. If the user clicks on the component area 1416, the user is prompted with a component pop-up list 1432 to facilitate selection of the component 80 to be injected into the component area 1416 and to reduce human error in identifying the particular component 80.

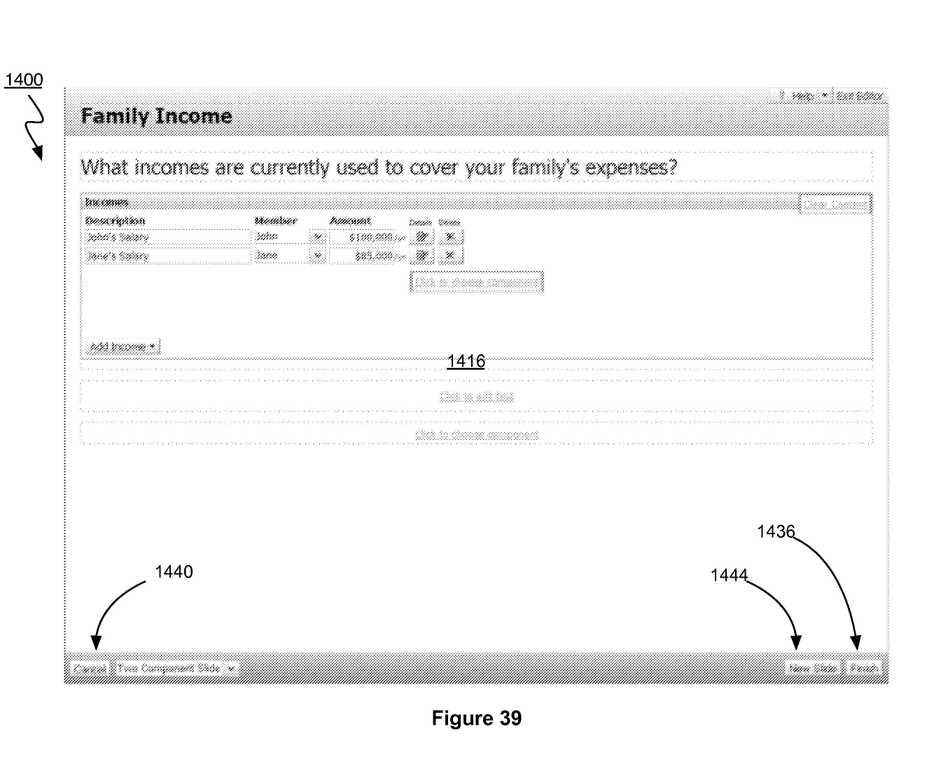

FIG. 39 shows the display of a selected component 80 in the component area 1416. Once selected, that component 80 is displayed in the component area 1416 as it generally is displayed when the slide is viewed via the presentation player 74. Planning data from the currently-open plan is also displayed within the fields of the component 80. Note that the component 80 is not “live”, in that the user cannot, in the presentation editor 72, edit the data in the fields of the component 80. The user, however, can click on the component 80 to replace it with a different component 80. When the component 80 is selected and added to the slide 1400, a reference to the component 80 is added to the associated slide definition 92 for the slide 1400.

Once the user has entered all of the text for the slide 1400 and selected the appropriate input and/or output components 80, the user can click a “Finish” button 1436 to complete the slide editing process. Alternatively, the user can click a “Cancel” button 1440 to discard all changes that were made. Further, the user can click a “New Slide” button 1444 to save the current slide and create another new slide.

Once the user completes editing the slide 1400, the slide definition 92 for the slide 1400 is saved. If the slide is a new slide, a reference to the slide is added to the presentation definition 94 for the presentation being edited.

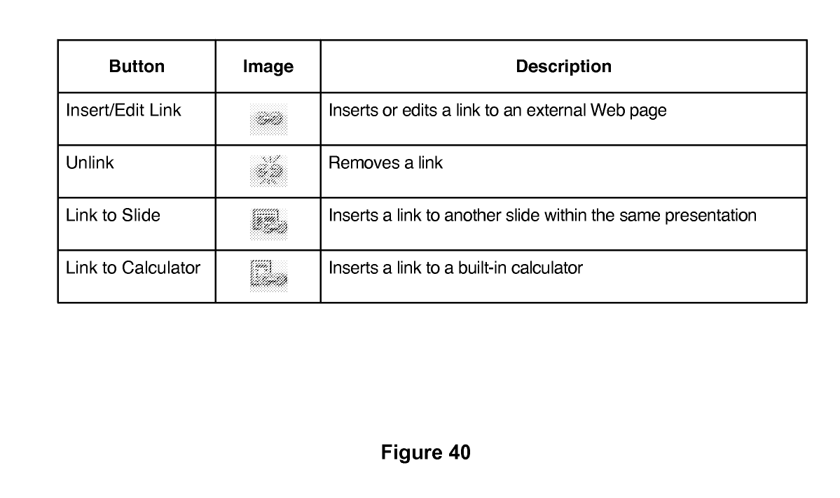

FIG. 40 illustrates a table of link insertion buttons and their descriptions for inserting links into text areas of slides. This is done using the HTML editor controls 1428, which will insert the necessary HTML to handle the link into the text area. A button is provided to insert links to external Web pages, which are brought up in a separate window. Another button enables removal of a previously-created link. In addition, other buttons enable linking to existing slides within the same presentation or to a built-in calculator.

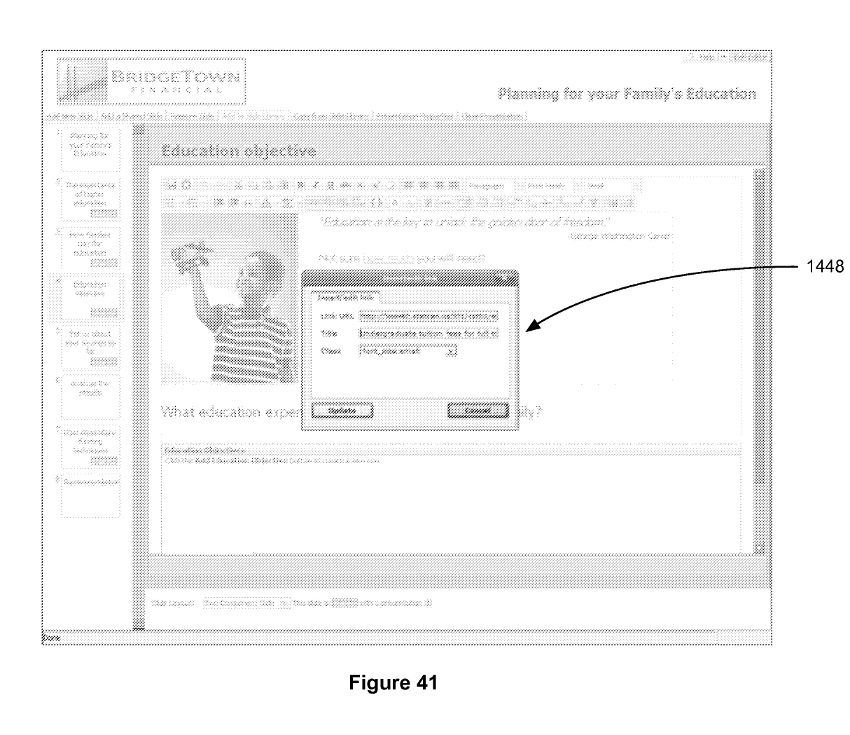

FIG. 41 shows a pop-up window 1448 that is displayed by the presentation editor 72 when a user selects to insert a link to an external Web page into a slide. The pop-up window 1448 is generated using an HTML DIV element.

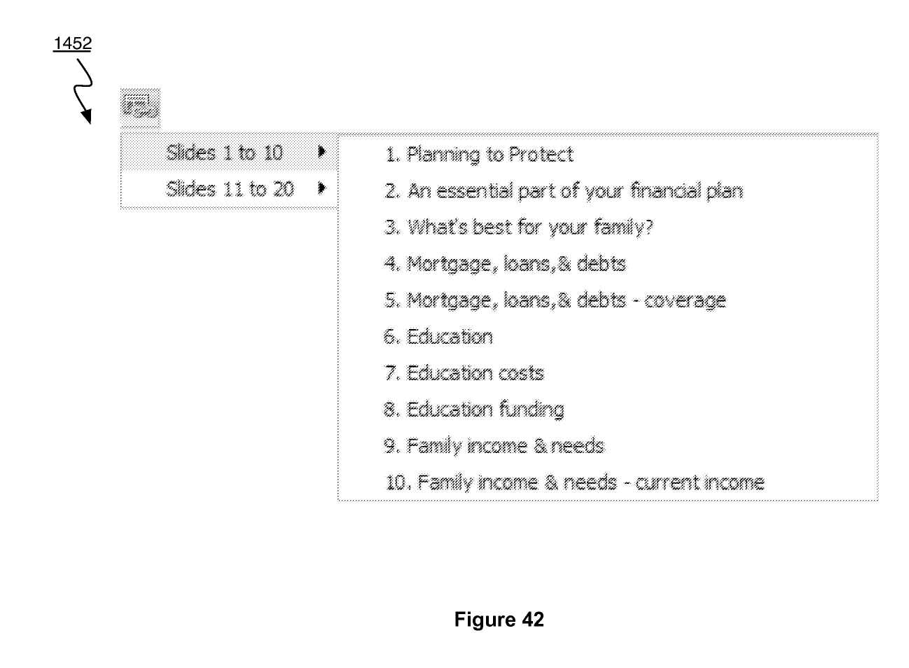

FIG. 42 shows a slide drop-down list 1452 that is displayed by the presentation editor 72 when a user selects to insert a link to an existing slide in the same presentation.

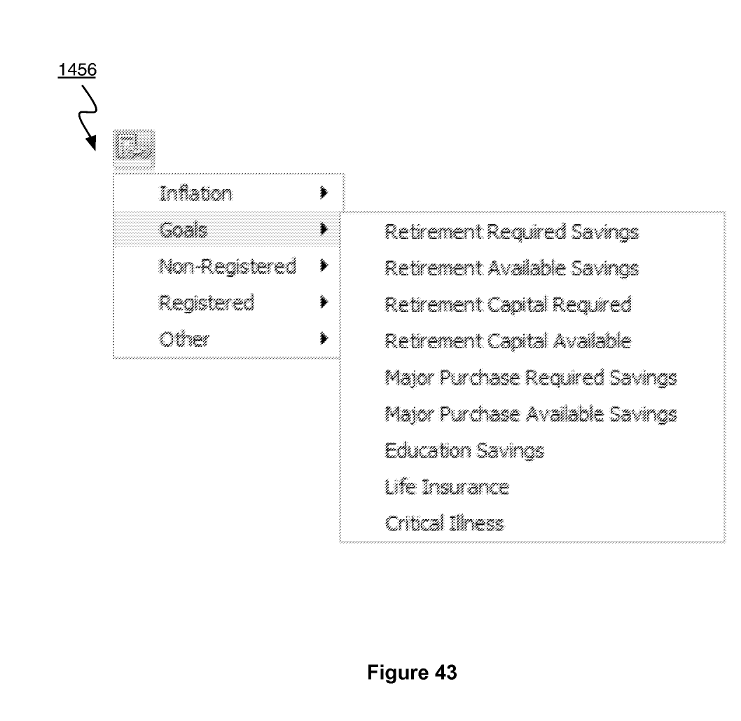

FIG. 43 shows a calculator drop-down list 1456 that is displayed by the presentation editor 72 when a user selects to insert a link to a built-in calculator.

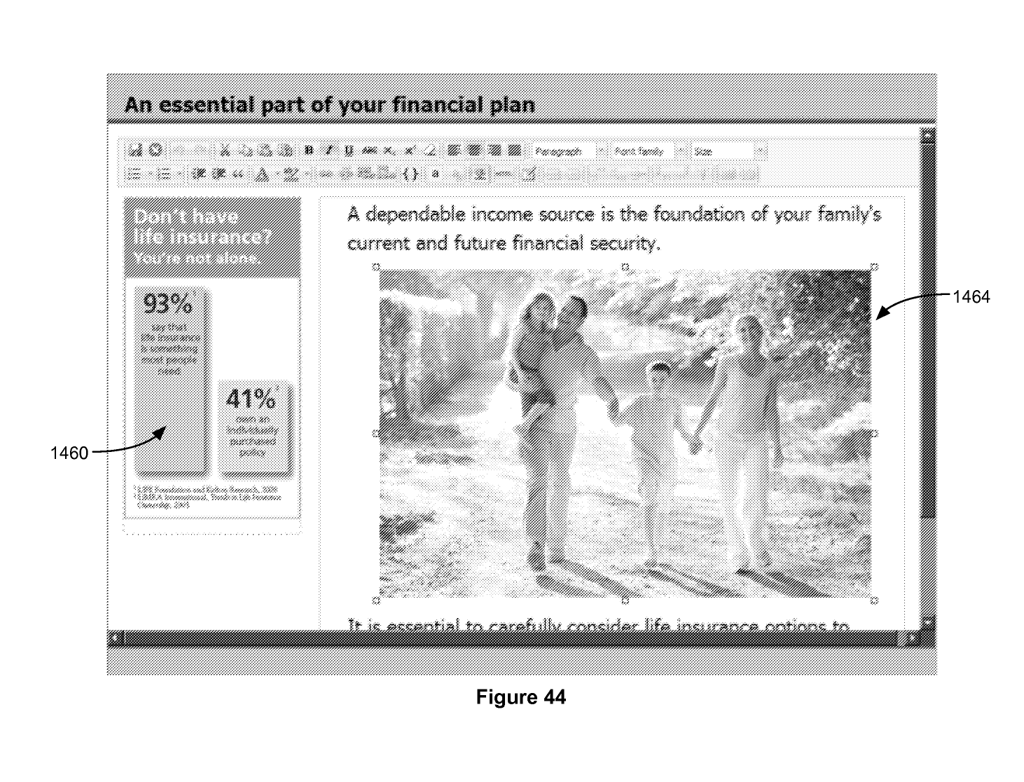

FIG. 44 shows the insertion of static images 1460, 1464 into a text area of a slide using the presentation editor 72. The image source can be an external image referenced by its uniform resource locator (“URL”) or it could be one of the images 90 forming part of the resources 72 of the financial planning system 20. The images can be positioned relative to the text in the text area and justified on the page (i.e., centered, scaled, etc.). Further, the images may be the only contents of a text area. Other types of media, such as audio, video and Adobe Flash, can be similarly added to a slide.

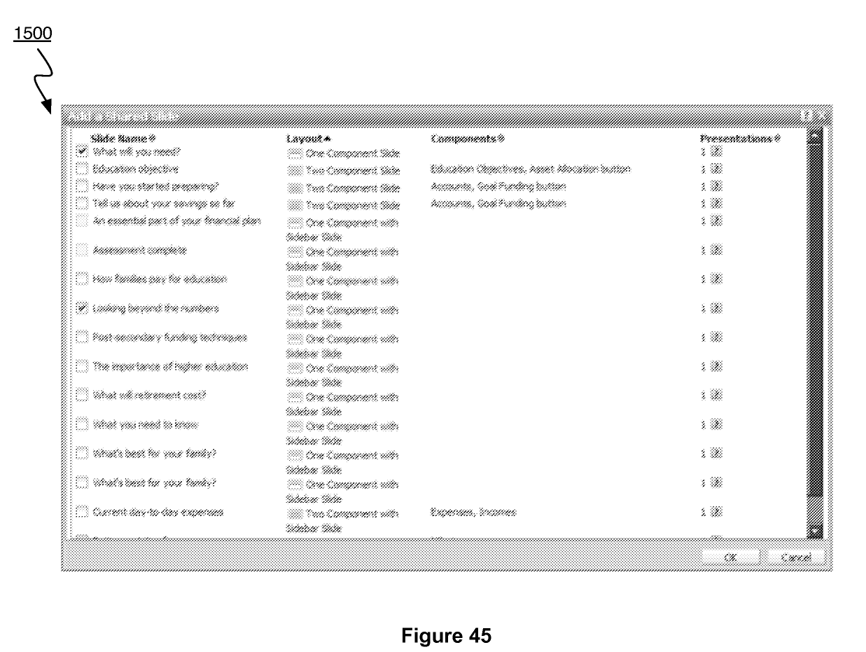

FIG. 45 shows a dialog box 1500 generated by the presentation editor 72 when the “Add a Shared Slide” button 1212 shown in FIG. 33 is activated when editing a presentation. The financial planning system 20 has a library of pre-defined slides (i.e., slide definitions) that can be used to create presentations. Slides can be added to or removed from the slide library. Slides in the library are called “shared” slides. The dialog box 1500 presents a user with a list of the available shared slides along with what components each slide uses (if any) and what presentations are already using the slide. The user can select one slide or multiple slides from the list and click OK to have them inserted into the presentation currently being edited.

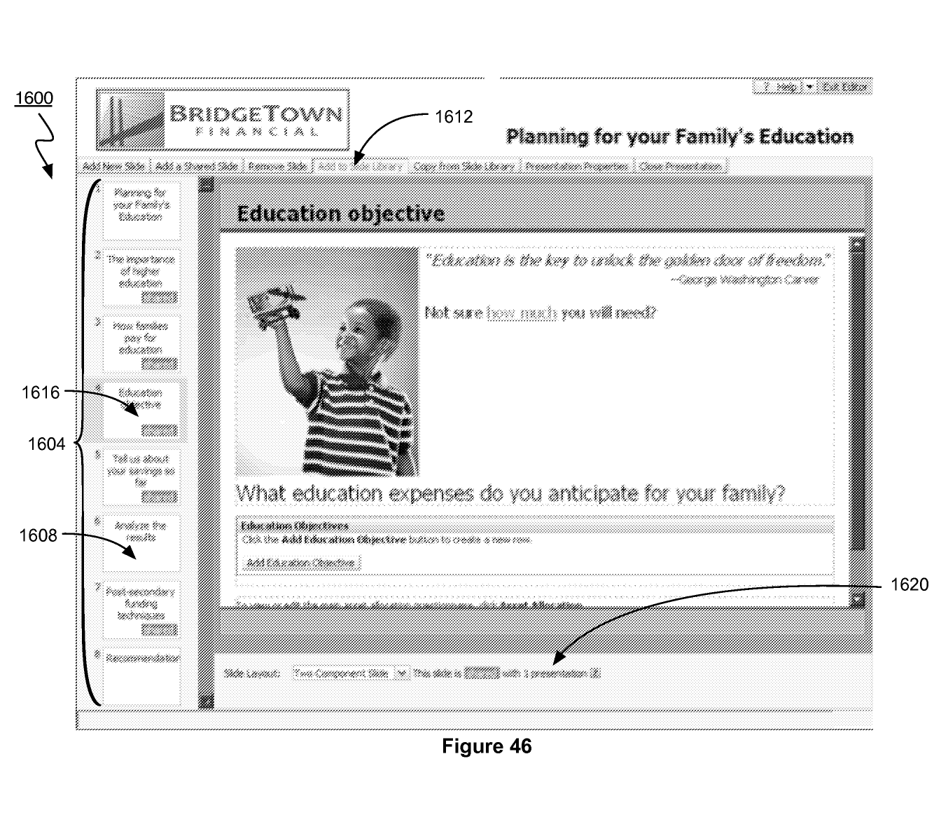

FIG. 46 shows a presentation editor screen 1600 similar to the presentation editor screen 1200 of FIG. 33, wherein thumbnail images 1604 similar to the thumbnail images 1204 for certain slides that are shared indicate their shared status. When a slide 1608 in a presentation that is a shared slide is selected, an “Add to Slide Library” button 1612 is grayed-out, indicating that the selected slide is already in the slide library. The thumbnail image 1604 for a currently-selected slide 1616 is highlighted on the left side, indicating that this is the slide being edited. The thumbnail image 1604 for the currently-selected slide 1616 visually indicates that it is shared, and shared slide information 1620 at the bottom of the slide indicates that the slide is shared with one other presentation. Note that any changes to shared slides will be effected for all of the presentations that use the shared slide.

Referring back to FIG. 29, selection of the “Slide Library” editor tab 1004 enables management of the shared slides.

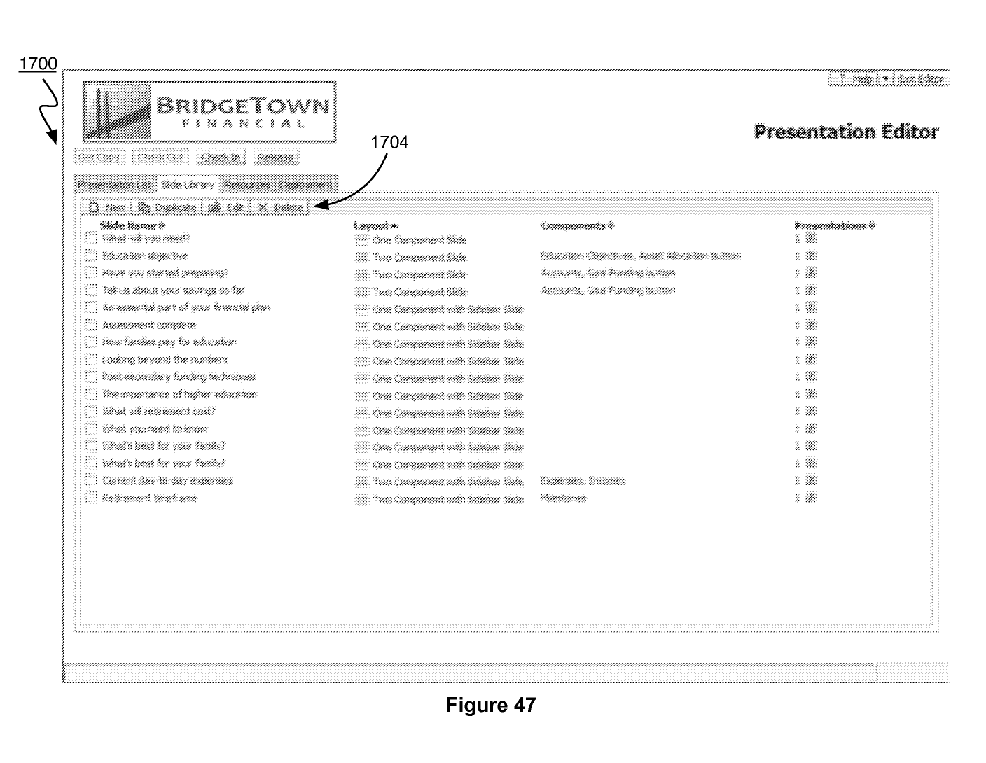

FIG. 47 shows a slide management screen 1700 of the presentation editor 72 that enables management of the shared slides in the slide library. The slide management screen 1700 displays a list of the shared slides, the slide layout 88 and the component(s) 80 used for each of the shared slides, and the number of presentations that employ the shared slide. Slide management buttons 1704 enable the creation of a new shared slide, and the duplication, editing or deletion of an existing shared slide.

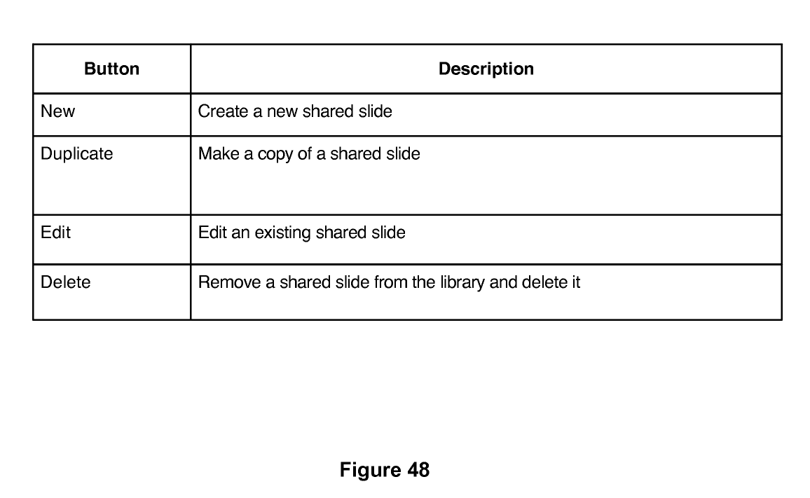

FIG. 48 is a table of the slide management buttons 1704 of FIG. 47 and their functions.

Referring back to FIG. 29, selection of the “Resources” editor tab 1004 enables management of the resources 76 of the financial planning system 20.

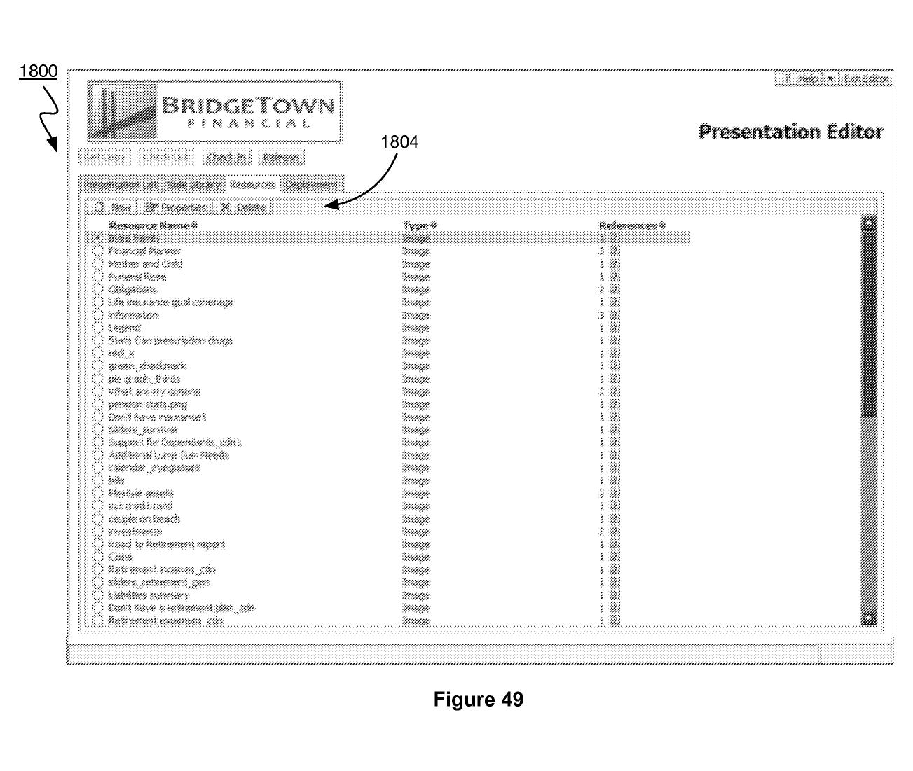

FIG. 49 shows a resource management screen 1800 of the presentation editor 72 that enables management of the resources available to the financial planning system 20. The resource management screen 1800 displays a list of the resources, the resource type, and the number of references that exist in all slides to the particular resource. Resource management buttons 1804 enable the creation of a new resource, the viewing of a selected resource's properties and its deletion.

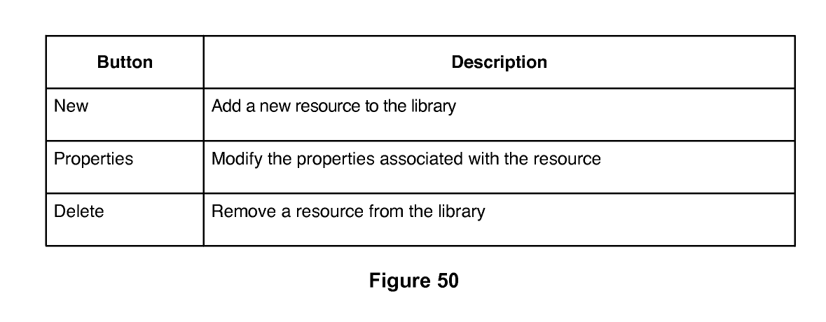

FIG. 50 is a table of the resource management buttons 1804 and their functions.

### Summary

The end result of using the presentation editor 72 to create a presentation is that new resources are generated as XML files (slides and presentations) and new content is imported (images, video files, etc.) and added to the resource libraries. Existing slides and presentation definitions are modified by the presentation editor 72 to effect the edits made by a user via the presentation editor 72.

The pre-defined components 80 and function objects 82 enable financial planning interfaces to be quickly developed and deployed. As the components and function objects can be tested prior to provisioning with the financial planning system 20, they can be safely used as building blocks in whatever interface a developer has in mind. Further, as the components and the function objects are used across all interfaces for interacting with the same financial planning engine 64, the consistency of financial planning results across the various interfaces can be more easily provided.

Without the presentation editor 72 of the presentation module 70, the process of creating these resources would consist of handcrafting a set of interrelated XML files, requiring considerable technical expertise and time. With the presentation editor 72, the process of creating a new presentation or editing an existing one is relatively simple and can be performed by a non-technical user (e.g., business analysis or marketing staff). In addition, the process is extremely fast compared to handcrafting the XML needed to implement a presentation and all the slides within a presentation.

While the above-described embodiment was described with reference to Web interfaces, it will be appreciated that other development platforms can be used with the invention. For example, the entire system can be implemented in a desktop platform such as, for example, Microsoft Windows Presentation Foundation.

While the system is described as a set of computers coupled together, those skilled in the art will appreciate that other configurations can be used without departing from the spirit of the invention. For example, a single computer could provide all of the functionality.

Other mechanisms for asynchronously exchanging data between the interface being directly interacted with by the user and the financial planning system apart from AJAX will occur to those skilled in the art. For example, in a desktop application, communication with the financial planning engine 64 can be executed directly from the user interface in memory.

The various resources can be stored on any type of computer-readable medium, such as a computer system's volatile or non-volatile storage, an optical disk, flash memory media, etc.

It is advantageous to use a presentation editor such as described above to facilitate the generation of slide and presentation definitions, but it may be desirable in some cases to manually code these while still benefiting from the pre-defined tested components and function objects.

The above-described embodiments are intended to be examples of the present invention and alterations and modifications may be effected thereto, by those of skill in the art, without departing from the scope of the invention, which is defined solely by the claims appended hereto.

What is claimed is:

1. A system for enabling financial planning, comprising:
a financial planning engine for generating financial plans;
storage;
a client database maintained in said storage for storing client data, said client data including personal data and client parameters; and
a set of pre-defined components stored in said storage, said components comprising a set of controls for communicating data with said client database, and for presenting outputs from said financial planning engine, said pre-defined components being designed to be included in a financial planning interface,
said financial planning engine having a set of pre-defined function objects, each of said function objects corresponding to one of said components and being used by said financial planning engine for handling communication with said one component.

2. The system of claim 1, further comprising:
a set of pre-defined slide layouts stored in said storage, said slide layouts having areas for receiving said components to generate said financial planning interface.

3. The system of claim 2, further comprising:
slide definitions stored in said storage, said slide definitions defining the assembly of said slide layouts and said components into slides.

4. The system of claim 3, further comprising:
presentation definitions stored in said storage, said presentation definitions identifying a plurality of said slide definitions representing said slides to be assembled into a presentation.

5. The system of claim 4, further comprising:
a presentation editor for generating said slide definitions and said presentation definitions.

6. The system of claim 4, further comprising:
a presentation player for providing access to said financial planning interface, said presentation player assembling said slide layouts and said components in said storage according to said slide definitions to generate said slides of said financial planning interface.

7. The system of claim 6, wherein said presentation player is accessible via a Web interface.

8. The system of claim 6, wherein at least two of said presentation definitions identify a common one of said slide definitions.

9. The system of claim 6, wherein said presentations are linked to a launch page available through said presentation player.

10. The system of claim 9, wherein said launch page permits selection of a client whose client data is used for said presentations.

11. The system of claim 6, wherein said presentation player inserts navigation controls in said slides.

12. The system of claim 5, wherein said presentation editor provides a graphical user interface for creating said slides and said presentations.

13. The system of claim 1, wherein said set of controls enables the generation of a financial plan via said financial planning engine for a selected client.

14. The system of claim 13, wherein said components enable the display of said financial plan generated by said financial planning engine.

15. The system of claim 1, wherein said components perform validity checks on data inputted via said controls.

16. The system of claim 1, wherein said function objects perform validity checks on data received from said components.

17. A method for enabling financial planning, comprising:
providing a set of pre-defined components, said components comprising a set of controls for communicating data with a client database that includes personal data and client parameters, and for presenting outputs from a financial planning engine for generating financial plans, said pre-defined components being designed to be included in a financial planning interface; and
providing said financial planning engine having a set of pre-defined function objects, each of said function objects corresponding to one of said components, said function objects being used by said financial planning engine for handling communication with said components.

18. The method of claim 17, further comprising:
providing a set of pre-defined slide layouts having areas for receiving said components to generate said financial planning interface.

19. The method of claim 18, further comprising:
assembling said slide layouts and said components to generate said financial planning interface.

20. The method of claim 19, further comprising:
generating slide definitions defining the assembly of said slide layouts and said components into slides.

21. The method of claim 19, further comprising:
assembling said slide layouts and said components according to slide definitions.

22. The method of claim 21, further comprising:
assembling a presentation according to a presentation definition identifying a plurality of said slide definitions representing slides.

23. The method of claim 20, further comprising:
generating a presentation definition identifying a plurality of said slide definitions representing said slides to be assembled into a presentation.

24. The method of claim 20, further comprising:
receiving input data via one of said components in said slides; and
storing said input data in said client database.

25. The method of claim 20, further comprising:
receiving a request for a calculation from said financial planning engine via one of said components in said slides;
performing said calculation using said input data; and
sending said calculation from said financial plan to said one component.

26. A system for enabling financial planning, comprising:
a set of slides stored on a computer-readable medium, said slides being assembled from slide layouts and pre-defined components, said components comprising a set of controls for communicating data with a client database that includes personal data and client parameters, and for presenting outputs from a financial planning engine for generating financial plans, said financial planning engine having a set of pre-defined function objects, each of said function objects corresponding to one of said components, said function objects being used by said financial planning engine for handling communication with said components.

27. A method for enabling financial planning, comprising:
providing a set of pre-defined components, said components comprising a set of controls for communicating data with a client database that includes personal data and client parameters, and for presenting outputs from a financial planning engine for generating financial plans, said financial planning engine having a pre-defined set of function objects, each of said controls corresponding to one of said set of pre-defined function objects and generating events handled by said one function object; and
assembling said components into slides for presentation to a user.
